(19) United States
(12) Patent Application Publication
(10) Pub. No.: US 2014/0226197 A1
(43) Pub. Date: Aug. 14, 2014

(54) OPTICAL ELEMENT AND PROJECTION-TYPE DISPLAY DEVICE USING SAME

(71) Applicants: Masanao Natsumeda, Tokyo (JP); Masao Imai, Tokyo (JP); Shin Tominaga, Tokyo (JP); Naofumi Suzuki, Tokyo (JP); Mizuho Tomiyama, Tokyo (JP); Yuji Ohno, Tokyo (JP)

(72) Inventors: Masanao Natsumeda, Tokyo (JP); Masao Imai, Tokyo (JP); Shin Tominaga, Tokyo (JP); Naofumi Suzuki, Tokyo (JP); Mizuho Tomiyama, Tokyo (JP); Yuji Ohno, Tokyo (JP)

(73) Assignee: NEC CORPORATION, Tokyo (JP)

(21) Appl. No.: 14/347,336

(22) PCT Filed: Jul. 13, 2012
(86) PCT No.: PCT/JP2012/067943

§ 371 Date: Mar. 26, 2014

(30) Foreign Application Priority Data
Sep. 27, 2011 (JP) 2011-211603
Jan. 6, 2012 (JP) 2012-001325

(51) Int. Cl. G02B 5/00

(52) U.S. Cl. CPC G02B 5/008
USPC 359/241

(57) ABSTRACT

An optical element is provided with a plasmon excitation layer that facilitates both the control of plasmon resonant conditions and the improvement of conversion efficiency. The plasmon excitation layer that is provided in the optical element generates surface plasmons, and the plasmon excitation layer is made up of metal and a dielectric.

### TECHNICAL FIELD

The present invention relates to an optical element that uses surface plasmons to emit light.

### BACKGROUND ART

In recent years, surface plasmons are receiving increasing attention in the fields of light source devices and illumination devices. Surface plasmons are groups of free electrons that vibrate in metals and are excited at the metal surface by the interaction of metal and light.

Non-Patent Document 1 describes an optical element in which surface plasmons are used to increase the light intensity of fluorescent light that is emitted by a fluorescent material. In this optical element, a metal thin-film and a dielectric layer having a grating structure are sequentially laminated on a substrate. In addition, quantum dots that function as a fluorescent material are applied to the dielectric layer.

When light is irradiated upon the quantum dots, excitons in the quantum dots are excited by the incident light. A portion of the excitons radiates fluorescent light, and the remaining excitons are consumed by the excitation of the surface plasmons and the generation of electron-positive hole pairs and vanish without radiating fluorescent light. When a dielectric layer has a grating structure as described hereinabove, the surface plasmons that are excited at the interface of the metal thin-film and dielectric layer can be diffracted and extracted as light that is identical to fluorescent light.

Accordingly, in the optical element described in Non-Patent Document 1, the light intensity of fluorescent light can be augmented because photons that are extracted by the diffraction of surface plasmons are added to the photons that are extracted when there is no grating structure. As a result, applying the optical element described in Non-Patent Document 1 to a fluorescent illumination device that is illuminated by fluorescent light enables an improvement of the luminance of the fluorescent illumination device.

### LITERATURE OF THE PRIOR ART

### Non-Patent Document

Non-Patent Document 1: Ehren Hwang, Igor I. Smolyaninov, Christopher C. Davis, NANO LETTERS, 2010, 10. pp. 813-820.

### SUMMARY OF THE INVENTION

### Problem to be Solved by the Invention

In an optical element that uses surface plasmons, the coupling efficiency η_{coup} of the light-surface plasmon conversion when surface plasmons are generated from light and the extraction efficiency ηₑₓₚ of the surface plasmons-light conversion when light is generated from surface plasmons are of critical importance.

FIG. 1 is a view for describing the conversion efficiency via surface plasmons in a reflective optical element that uses fluorescent light and that is disclosed in Non-Patent Document 1, FIG. 1(a) being a sectional view showing the configuration of the optical element and FIG. 1(b) showing the state of light from irradiation to emission.

The optical element shown in FIG. 1(a) is made up of a metal film (Ag) formed on substrate 14, grating 12 that is realized by a dielectric in which a grating structure is formed, and fluorescent material 11 that covers grating 12.

As shown in FIG. 1(b), surface plasmon polaritons (SPP) are generated between metal layer 13 and grating 12 by the incident light. The generation rate at this time is proportional to the coupling efficiency η_{coup}. On the other hand, surface plasmons are diffracted by the grating construction of grating 12 to generate emission light. The generation rate at this time is proportional to extraction efficiency ηₑₓₚ.

As described hereinabove, the conversion efficiency of a configuration in which surface plasmons are generated from light and in which light is further generated from surface plasmons depends on the product of the coupling efficiency η_{coup}×extraction efficiency ηₑₓₚ. This dependence holds true not only for a reflective optical element that uses the surface plasmons as shown in FIG. 1 but also for a transmissive optical element that uses plasmon coupling as shown in FIG. 2.

FIG. 2 is a view for describing the conversion efficiency in a transmissive optical element that uses plasmon coupling, FIG. 2(a) being a sectional view showing the configuration of the optical element, and FIG. 2(b) showing the state of light from irradiation to emission.

The optical element shown in FIG. 2(a) is an element for causing incident light, that is irradiated into light guide body 21, to be emitted as incident radiation 27 that features improved directivity and is an element in which carrier generation layer 22, low-dielectric constant layer 23, plasmon excitation layer 24, high-dielectric constant layer 25, and wave vector conversion layer 26 are formed on light guide body 21. In the light that is propagated by total reflection in light guide body 21, the total reflection conditions break down at the interface of light guide body 21 and carrier generation layer 22, and a portion of the light is irradiated into carrier generation layer 22. The light that is irradiated into carrier generation layer 22 generates carriers in carrier generation layer 22. The carriers that are generated cause plasmon coupling with free electrons in plasmon excitation layer 24 by way of low-dielectric constant layer 23. Radiation into high-dielectric constant layer 25 is generated by this plasmon coupling, and this light is diffracted at wave vector conversion layer 26 and emitted to the outside as radiation 27.

As shown in FIG. 2(b), plasmon coupling occurs between plasmon excitation layer 24 and low-dielectric constant layer 23. The generation rate at this time is proportional to coupling efficiency η_{coup}. On the other hand, radiation is generated into high-dielectric constant layer 25. The generation rate at this time is proportional to extraction efficiency ηₑₓₚ.

As described hereinabove, in a transmissive optical element that uses plasmon coupling, the conversion efficiency is dependent on the product of coupling efficiency η_{coup}×extraction efficiency ηₑₓₚ, and in order to increase the conversion efficiency, the product of coupling efficiency η_{coup}×extraction efficiency ηₑₓₚ must be increased in either a transmissive or reflective optical element.

The coupling efficiency η_{coup} can be maximized by matching the light emission wavelength to the wavelength at which the wave number of the surface plasmons is a maximum. This will be explained with reference to FIGS. 3 and 4.

FIG. 3 is a sectional view showing the configuration of a reflective optical element in which radiation is realized by means of surface plasmons, and FIG. 4 shows the characteristics relating to plasmons of the optical element.

The optical element shown in FIG. 3 is an element in which GaN layer 32, InGaN layer 33 that is an InGaN quantum well, GaN spacer layer 34 that is a thin GaN layer, and metal film 35 are laminated on sapphire substrate 31. Excitation light is irradiated by way of sapphire substrate 31 to generate carriers in InGaN layer 33, and these carriers excite surface plasmons in the interface of metal film 35 and GaN spacer layer 34. The excited surface plasmons are again converted to light to generate radiation 37. The light that is again extracted as light by way of surface plasmons is hereinbelow referred to as plasmon light.

FIGS. 4(a)-(c) show the intensity of plasmon light, the enhancement ratio realized by plasmon light, and the wave number of surface plasmons, respectively, when using Ag, Al, and Au as metal film 35, these values being shown by the vertical axes. In addition, the horizontal axis in each case shows wavelength.

The intensity of plasmon light is highest when Ag is used in metal film 35, as shown in FIG. 4(a), and the enhancement ratio is also high as shown in FIG. 4(b). Wavelengths at which the coupling efficiency is high are regions enclosed by circles ◯ which are practical wavelength regions at which the enhancement ratio is highest, and at these wavelengths, the wave number of surface plasmons is a maximum as shown in FIG. 4(c). In other words, coupling efficiency η_{coup} can be maximized by matching the emission wavelength of the carrier generation layer with the wavelength at which the wave number of surface plasmons is a maximum.

Adjustment of the resonant condition of plasmons by means of the type of metal film is next described with reference to FIG. 5.

FIG. 5 is a view for describing the extraction efficiency ηₑₓₚ and shows reflectance when light having a wavelength of 530 nm is irradiated while varying the angle of incidence into an element in which SiO₂, a metal film (Metal), and TiO₂ are laminated on quantum dots (QD), the horizontal axis showing the angle of incidence and the vertical axis showing the reflectance or transmittance. “Au” and “Ag” in the legend show the reflectance of TM polarized light when the metal is made Au and Ag, respectively. The reflectance of TM polarized light shown on the vertical axis correlates with the extraction efficiency of plasmon light, the extraction efficiency ηₑₓₚ of plasmon light increasing as the reflectance of TM polarized light decreases. The angle of incidence shown on the horizontal axis can be shown by replacing it with the wave number of surface plasmons and therefore correlates with coupling efficiency, the coupling efficiency increasing in correspondence with an increase in angles having a large drop in the reflectance of TM polarized light. As can be seen from FIG. 4 and FIG. 5, the appropriate metal for the metal film is Ag in the region of wavelengths from 440 nm to 600 nm, and the appropriate metal for the metal film is Au for the region of wavelengths from 550 nm to 750 nm.

The adjustment of the resonant condition of plasmons by means of the type of dielectric is next described with reference to FIG. 6.

FIG. 6 shows the change in the resonant condition resulting from the type of dielectric and shows the relation between the wave number kₛₚₚ and wavelength λ, (nm) of the X-component and Y-component of surface plasmons when the dielectric is varied among TiO₂, SiO₂, MgF₂, and air for an element in which the dielectric, Ag, and TiO₂ are laminated on quantum dots (QD).

The dielectric constant is highest for TiO₂ and decreases in order for SiO₂, MgF₂, and air, and the wave number kₛₚₚ differs according to the type of dielectric. Because there is no material that has a dielectric constant greater than TiO₂ and that is transparent within the range of visible light, bringing about resonance in a region of wavelengths longer than 500 nm is problematic.

Regarding the resonant condition of plasmons, efficiency is highest when the sum of the actual dielectric constant Re [∈ₘₑₜₐₗ] of the metal that constitutes the metal film and the actual dielectric constant Re [∈_{dielectric}] of the dielectric is “0,” i.e., when Re [∈ₘₑₜₐₗ]+Re [∈_{dielectric}]=0.

As an example, the dielectric constants of Ag, Au, Al, and TiO₂ at a wavelength of 530 nm are shown below:

Ag: −10.1+0.8i

Au: −5.4+2.3i

Al: −40.8+11.3i

TiO₂: 7.1

Based on the examples above, the conversion efficiency at an emission wavelength of 530 nm is increased by using, as the plasmon excitation layer, a material having a dielectric constant that approaches the dielectric constant of TiO₂ and for which the imaginary part is small.

It is an object of the present invention to provide an optical element that is equipped with a plasmon excitation layer that is capable of mutually converting light and surface plasmons under conditions of high conversion efficiency over the entire visible light region.

In the present invention, the conversion efficiency is increased by making the real part of the dielectric constant of the plasmon excitation layer at the emission wavelength approach as closely as possible the dielectric constant of the interface while preventing an increase in the imaginary part of the dielectric constant of the plasmon excitation layer, this imaginary part indicating the magnitude of Joule loss.

### Means for Solving the Problem

The optical element of the present invention is an optical element equipped with a plasmon excitation layer that generates surface plasmons wherein the plasmon excitation layer is made up of a metal and a dielectric.

An optical element is realized that is equipped with a plasmon excitation layer that facilitates both improvement of the conversion efficiency and control of the plasmon resonant condition.

### BRIEF DESCRIPTION OF THE DRAWINGS

FIG. 1 is a view for describing the conversion efficiency via surface plasmons in a reflective optical element that uses fluorescent light disclosed in Non-Patent Document 1, FIG. 1(a) being a sectional view showing the configuration of the optical element and FIG. 1(b) showing the state of light from irradiation to emission.

FIG. 2 is a view for describing the conversion efficiency in a transmissive optical element that uses plasmon coupling, FIG. 2(a) being a sectional view showing the configuration of the optical element and FIG. 2(b) showing the state of light from irradiation to emission.

FIG. 3 is a sectional view showing the configuration of a reflective optical element in which radiation is carried out by surface plasmons.

FIG. 4 shows the characteristics of a reflective optical element in which radiation is carried out by surface plasmons.

FIG. 5 is a view for describing extraction efficiency ηₑₓₚ.

FIG. 6 shows the variation in resonant conditions due to the type of dielectric.

FIG. 7 is a sectional view showing the configuration of an exemplary embodiment of the plasmon excitation layer that is the principal part of the optical element according to the present invention.

FIG. 8A shows the dependence of the resonance wavelength upon the fraction of dielectric for an Ag-dielectric composite.

FIG. 8B shows the dependence of the resonance wavelength upon the fraction of dielectric for an Au-dielectric composite.

FIG. 9A shows the dielectric constant of an Ag-dielectric composite.

FIG. 9B shows the dielectric constant of an Au-dielectric composite.

FIG. 10 shows the resonance angle of an optical element having an emission wavelength of 460 nm that uses the plasmon excitation layer shown in FIG. 7.

FIG. 11 shows the long wavelength change of the resonance wavelength of an optical element that uses the plasmon excitation layer shown in FIG. 7.

FIG. 12 shows the resonance angle of an optical element for an emission wavelength of 530 nm when the thickness of the plasmon excitation layer shown in FIG. 7 is 50 nm.

FIG. 13 shows the resonance angle of an optical element for an emission wavelength of 530 nm when the thickness of the plasmon excitation layer shown in FIG. 7 is 40 nm.

FIG. 14 shows the resonance angle of an optical element for an emission wavelength of 530 nm when the fraction of the dielectric material is changed in the plasmon excitation layer shown in FIG. 7.

FIG. 15 shows the long wavelength change of the resonance wavelength of an optical element when Ag is used as the metal of the plasmon excitation layer shown in FIG. 7.

FIG. 16 shows the long wavelength change of the resonance wavelength of an optical element when Au is used as the metal of the plasmon excitation layer shown in FIG. 7.

FIG. 17 shows the resonance angle of an optical element for an emission wavelength of 630 nm when Ag is used as the metal of the plasmon excitation layer shown in FIG. 7.

FIG. 18 shows the resonance angle of an optical element for an emission wavelength of 630 nm when Au is used as the metal of the plasmon excitation layer shown in FIG. 7.

FIG. 19 is a sectional view showing the configuration of another exemplary embodiment of the plasmon excitation layer that is the principal part of the optical element according to the present invention.

FIG. 20 shows the reflectance with respect to the angle of incidence when light having a wavelength of 530 nm is irradiated into optical elements that use the plasmon excitation layer shown in FIG. 19.

FIG. 21 shows the reflectance with respect to the angle of incidence when light having a wavelength of 530 nm is irradiated into optical elements that use the plasmon excitation layer shown in FIG. 19.

FIG. 22 shows the reflectance with respect to the angle of incidence when light having a wavelength of 530 nm is irradiated into optical elements that contain different types of metal as the plasmon excitation layer shown in FIG. 19.

FIG. 23 shows the reflectance with respect to the angle of incidence when light having a wavelength of 530 nm is irradiated into an optical element that uses a total of seven layers of metal-dielectric multilayer films as the plasmon excitation layer shown in FIG. 19.

FIG. 24 is a sectional view showing the configuration of an exemplary embodiment of the optical element according to the present invention.

FIG. 25 is a sectional view showing the configuration of another exemplary embodiment of the optical element according to the present invention.

FIG. 26 is a sectional view showing the configuration of another exemplary embodiment of the optical element according to the present invention.

FIG. 27 is a sectional view showing the configuration of another exemplary embodiment of the optical element according to the present invention.

FIG. 28 is a sectional view showing the configuration of another exemplary embodiment of the optical element according to the present invention.

FIG. 29 is a sectional view showing the configuration of another exemplary embodiment of the optical element according to the present invention.

FIG. 30 is a schematic view showing an LED projector in which the light source device of an exemplary embodiment is applied.

FIG. 31 is a view for describing the excitation wavelength and emission wavelength of a fluorescent material and the wavelength of the light source that is used in the LED projector in which the light source device of an exemplary embodiment is applied.

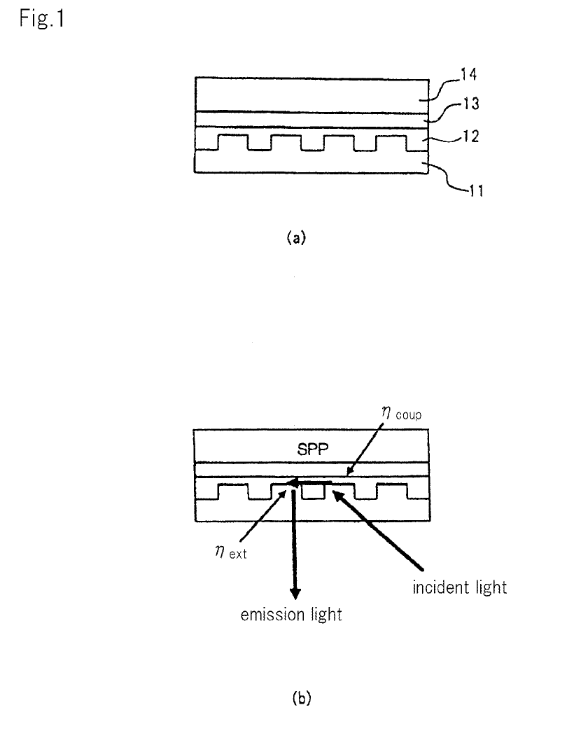

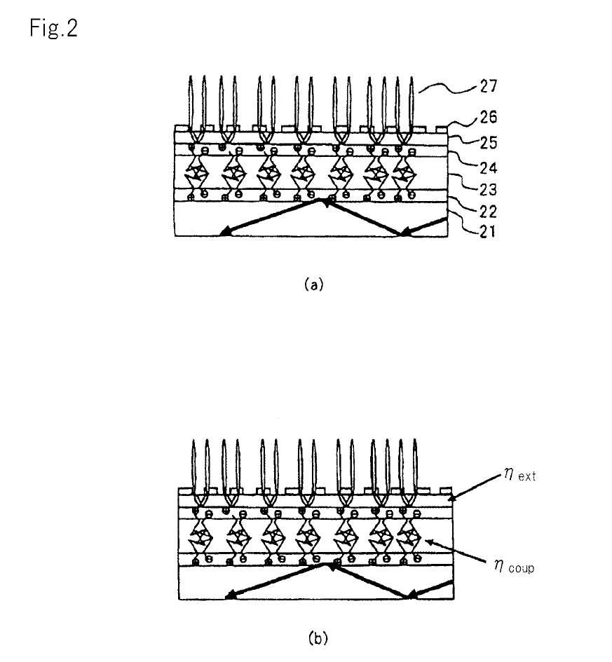

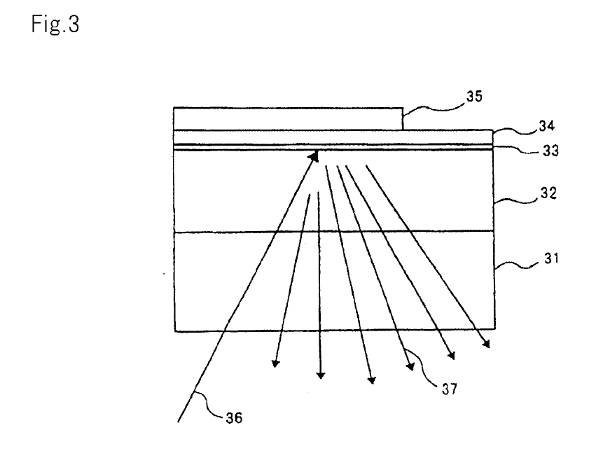

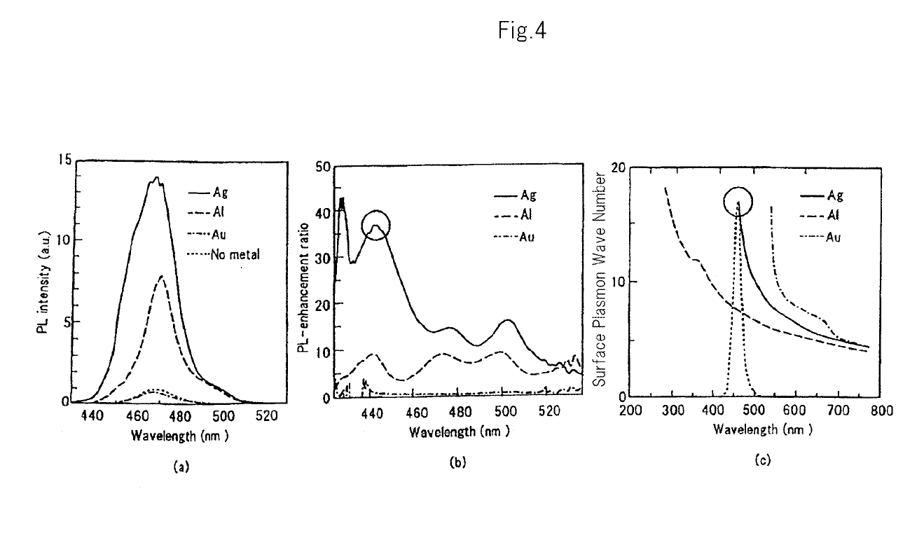

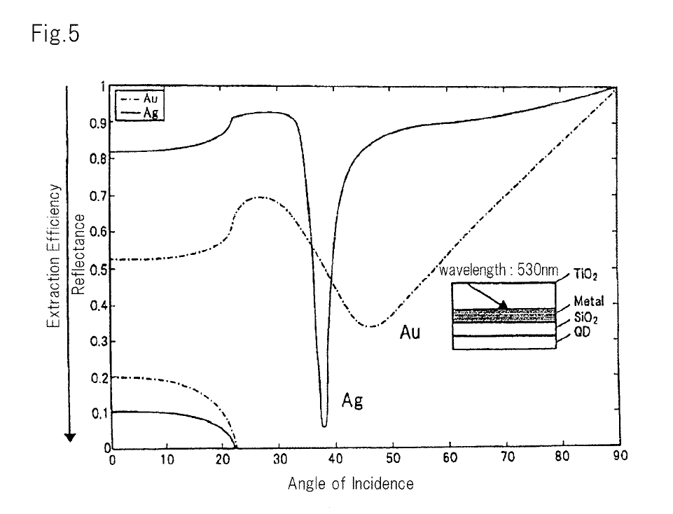

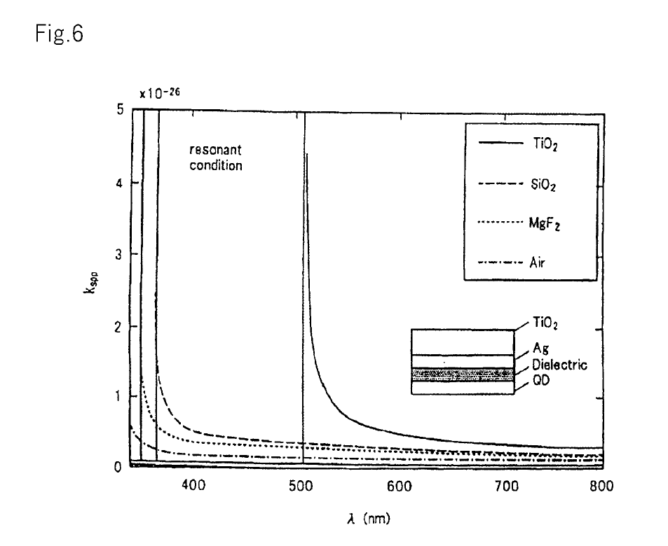

### BEST MODE FOR CARRYING OUT THE INVENTION

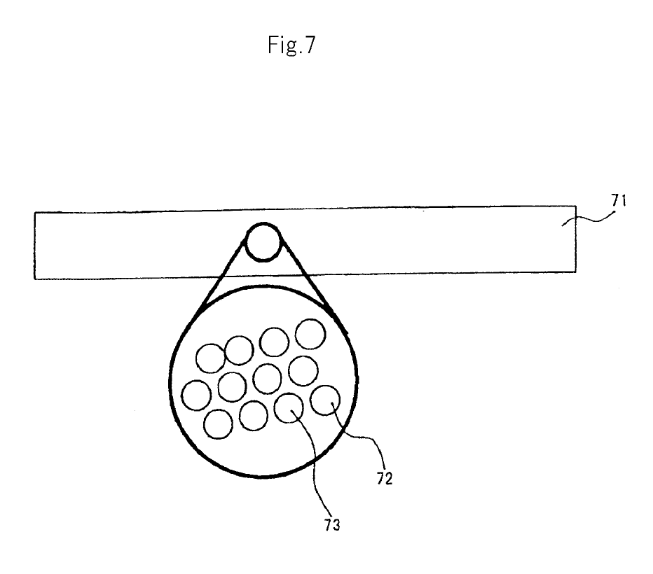

Exemplary embodiments of the present invention are next described with reference to the accompanying drawings. FIG. 7 is a sectional view showing the configuration of an exemplary embodiment of the plasmon excitation layer that is the principal part of the optical element according to the present invention.

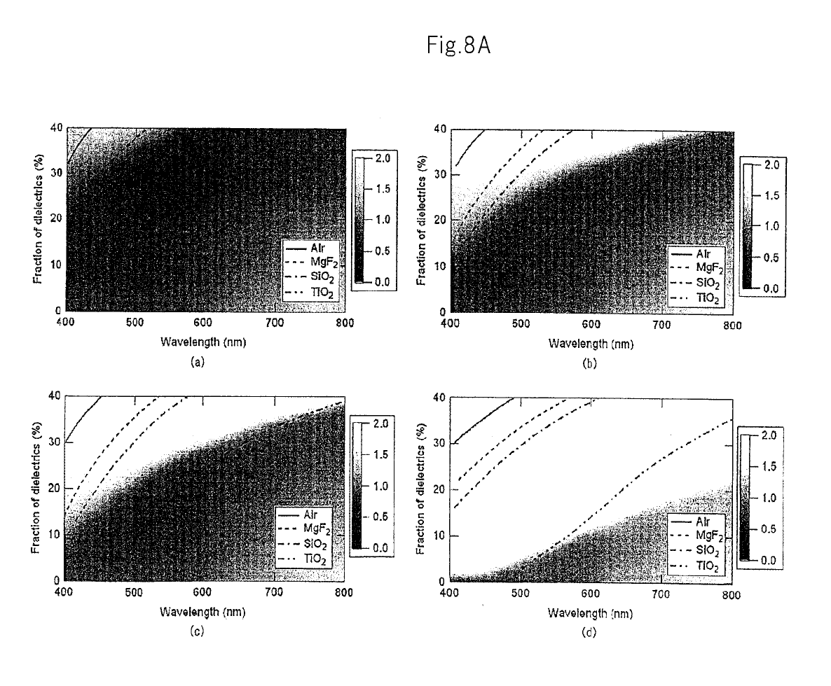

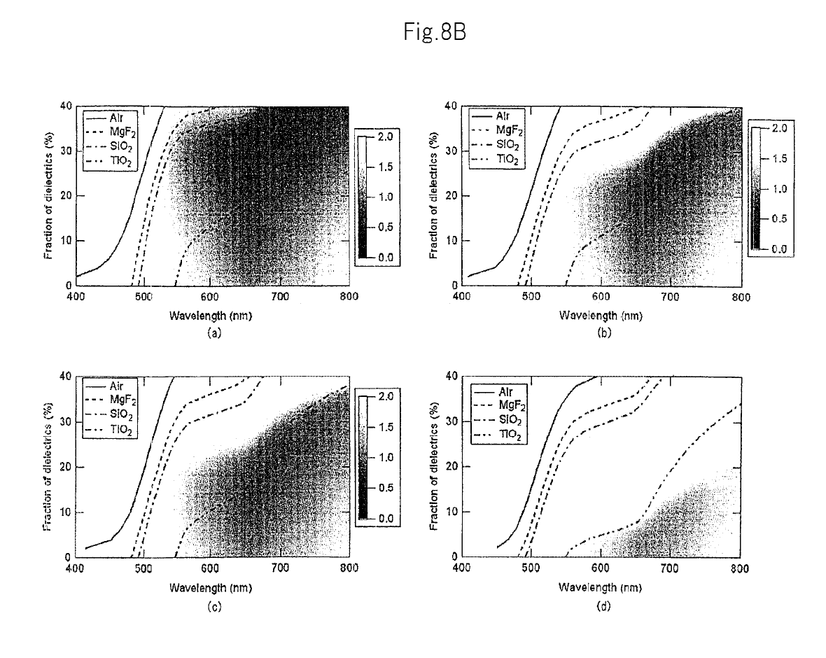

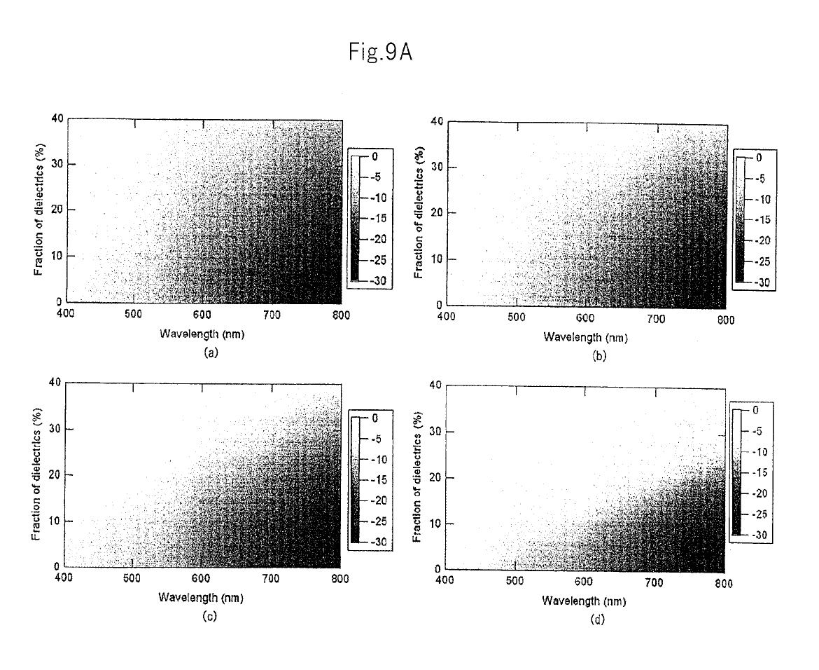

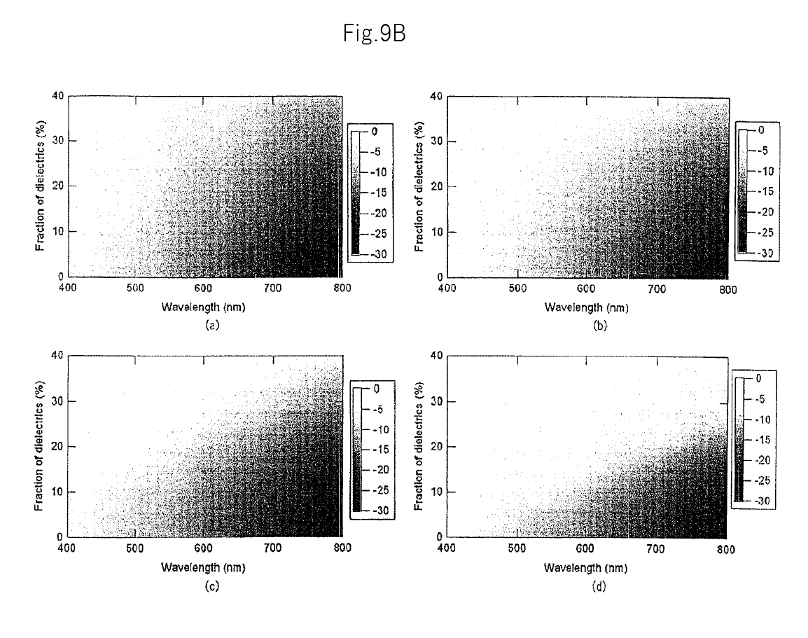

Plasmon excitation layer 71 according to the present exemplary embodiment is a composite realized by metal 72 and dielectric 73 as shown in the enlarged portion of the figure. A composite of this type can be fabricated by co-evaporation or co-sputtering, and Ag, Au, or an alloy of these metals can be used as the metal. For example, among alloys that use Ag, there is an Ag alloy having a Pd additive to improve protection against environment pollution. Alternatively, the metals that form the composite may be a plurality of types. The results of simulation are next described with reference to FIGS. 8A, 8B, 9A, and 9B. A Bruggeman effective medium approximation was used to find the complex dielectric constant of the metal-dielectric composite with respect to a 0-40% dielectric content ratio, and the resonance wavelength of the metal-dielectric composite was calculated. The metal used to make up the metal-dielectric composite was assumed to be Ag or Au, and the dielectric was assumed to be air, MgF₂, SiO₂, or TiO₂. In addition, the dielectric that is in contact with the metal-dielectric composite was assumed to be air, MgF₂, SiO₂, or TiO₂. Here, the dielectric constants of air, MgF₂, SiO₂, and TiO₂ increase in that order and are 1, 1.9, 2.4, and 7.1, respectively, for a wavelength of 530 nm. An infinite thickness is assumed in the direction of increasing distance from the interface of the metal-dielectric composite and the dielectric that is in contact with the metal-dielectric composite.

Assuming that ∈ₘ is the mean dielectric constant of the composite, ∈ᵢ is the dielectric constant of the material that makes up the composite, and φᵢ is the volume ratio of the materials that make up the composite (here, “i” represents integers, the number of integers being the number of materials that make up the composite. For example, if the composite is composed of two materials, “i” is the two numbers 1 and 2), the Bruggeman effective medium approximation equation in this case is a value that satisfies:

$$[ Equation 1 ]$$

$${\sum }_{i} {φ}_{i} \frac{{ɛ}_{i} - {ɛ}_{m}}{{ɛ}_{i} + 2 {ɛ}_{m}} = 0$$

In addition, assuming that ∈_{d} is the dielectric constant of the dielectric that is in contact with the metal-dielectric composite and λ is the wavelength of light in a vacuum, the resonance wavelength of surface plasmons is a value that satisfies:

∈_{d}(λ)+∈ₘ(λ)=0 [Equation 2]

FIG. 8A shows the dependence of the resonance wavelength upon the fraction of dielectric content for an Ag-dielectric composite. In the figure, (a) shows an Ag-Air composite, (b) shows an Ag—MgF₂ composite, (c) shows an Ag—SiO₂ composite, and (d) shows an Ag—TiO₂ composite. The legends show the dielectrics that are adjacent to the Ag-dielectric composites, and the backgrounds of the figures show the extinction coefficient of the composites. Portions in which the extinction coefficient exceeds “2” are shown whited out.

The resonance wavelength was obtained over the entire visible light band for any dielectric additive by adjusting the dielectric constant of the dielectric that is in contact with the Ag-dielectric composite. In addition, when the amount of added dielectric was the same, a greater shift in resonance wavelength was obtained when the dielectric constant of the composite was higher. On the other hand, the minimum value of the extinction coefficient was lower for cases in which the dielectric constant of the dielectric that made up the composite was lower. This minimum value was between wavelengths of 500 nm and 600 nm. Because the amount by which the extinction coefficient increases is greater than the shift in resonance wavelength that results from adding a dielectric that corresponds to the increase in the dielectric constant of the dielectric that makes up the composite, a dielectric having a low dielectric constant is preferable as the dielectric that makes up the Ag-dielectric composite. The optimum value of the fraction of dielectric content in the composite differs according to the constituent materials or the emission wavelength, but in any case is lower than 40%.

FIG. 8B shows the dependence of the resonance wavelength upon the fraction of the dielectric for an Au-dielectric composite. In the figure, (a) shows an Au-Air composite, (b) shows an Au—MgF₂ composite, (c) shows an Au—SiO₂ composite, and (d) shows an Au—TiO₂ composite. The legends show the dielectrics that are adjacent to the Au-dielectric composites, and the backgrounds of the graphs show the extinction coefficients of the composites. Portions in which the extinction coefficient surpasses “2” are shown whited out.

The resonance wavelength was obtained over the entire visible light band in any added dielectric by adjusting the dielectric constant of the dielectric that is in contact with the Au-dielectric composite. In addition, when the amount of added dielectric was the same, a greater shift in resonance wavelength was obtained when the dielectric constant of the composite was higher. On the other hand, the minimum value of the extinction coefficient was smaller for cases in which the dielectric constant of the dielectric that made up the composite was lower. This minimum value was between the wavelengths of 600 nm and 700 nm. Because the amount by which the extinction coefficient increases is greater than the shift in resonance wavelength that results from adding a dielectric that corresponds to the increase in the dielectric constant of the dielectric that makes up the composite, a dielectric having a low dielectric constant is preferable as the dielectric that makes up the Au-dielectric composite. The optimum value of the fraction of dielectric content in a composite differs according to the constituent materials or the emission wavelength, but in any case is lower than 40%. However, when Au is used as the metal, the extinction coefficient is high and therefore not practical regardless of which dielectric it is combined with for wavelengths less than 550 nm. When the extinction coefficients of composites that use Ag as the metal are compared with the extinction coefficients of composites that use Au, the composites that use Ag have lower extinction coefficients under all conditions at the resonance wavelength. Ag is therefore ideal as the metal of the composite over the entire visible light band. However, Ag is subject to sulfuration by hydrogen sulfide in the air, raising the problem of environmental resistance. In order to solve this problem, Au or an alloy that contains Ag or Au can be considered as the metal of the composite.

FIG. 9A shows the dielectric constant of Ag-dielectric composites. In the figure, (a) shows an Ag-Air composite, (b) shows an Ag—MgF₂ composite, (c) shows an Ag—SiO₂ composite, and (d) shows an Ag—TiO₂ composite. Portions in which the dielectric constant surpasses “0” are shown whited out. The dielectric constant approaches 0 as the fraction of the dielectric increases.

FIG. 9B shows the dielectric constant of Au-dielectric composites. In the figure, (a) shows an Au-Air composite, (b) shows an Au—MgF₂ composite, (c) shows an Au—SiO₂ composite, and (d) shows an Au—TiO₂ composite. Portions in which the dielectric constant surpasses “0” are shown whited out. The dielectric constant approaches 0 with greater fractions of the dielectric.

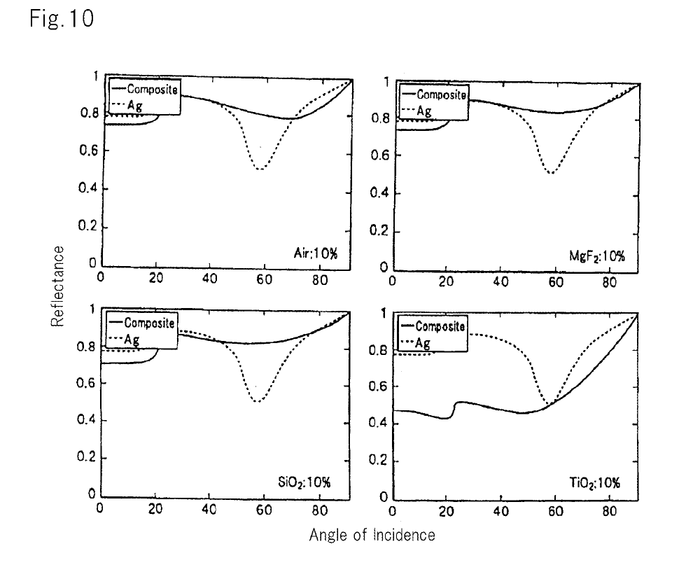

FIG. 10 shows the resonance angle of an optical element having an emission wavelength of 460 nm that uses the plasmon excitation layer shown in FIG. 7. As the optical element, an element was used in which SiO₂ as the dielectric layer, the plasmon excitation layer shown in FIG. 7, and TiO₂ were laminated on quantum dots, and the figure shows the results obtained when light was irradiated into the plasmon excitation layer via the TiO₂. “Composite” in the legends indicates a case in which a composite of Ag and a dielectric shown in the figure was used as the plasmon excitation layer, and “Ag” indicates a case in which simple Ag was used as the plasmon excitation layer. The percentages shown in the figures are the volume percentage of the dielectric in the Ag-dielectric composite. Explanations of similar legends are hereinbelow omitted. The plasmon excitation layer was a composite of Ag and a dielectric. The horizontal axis shows the angle of incidence, and the vertical axis shows the reflectance. From FIG. 10, a sudden drop in reflectance cannot be confirmed with a composite of Ag and a dielectric. In other words, at an emission wavelength of 460 nm, simple Ag is more appropriate than a composite of Ag and a dielectric.

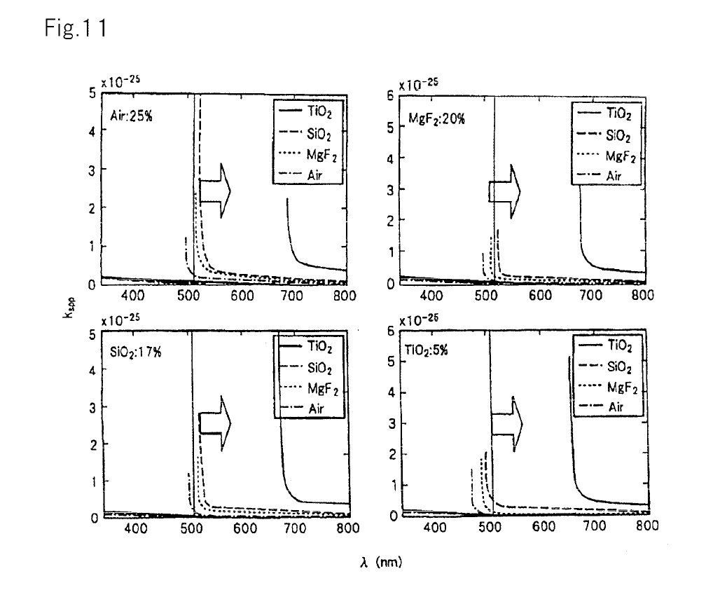

FIG. 11 shows the long wavelength change of the resonance wavelength of an optical element that uses the plasmon excitation layer shown in FIG. 7. As the optical element, an element was used in which the dielectric layer shown in the figure, the plasmon excitation layer shown in FIG. 7, and TiO₂ were laminated on quantum dots, and the figures show the results obtained when light was irradiated into the plasmon excitation layer via the TiO₂. The plasmon excitation layer was a composite of Ag and a dielectric. The horizontal axis shows the wavelength and the vertical axis shows the wave number. From FIG. 11, it can be seen that the amount of shift in the resonant condition with respect to the added amount is smaller for a dielectric having a low dielectric constant, i.e., fabrication is facilitated.

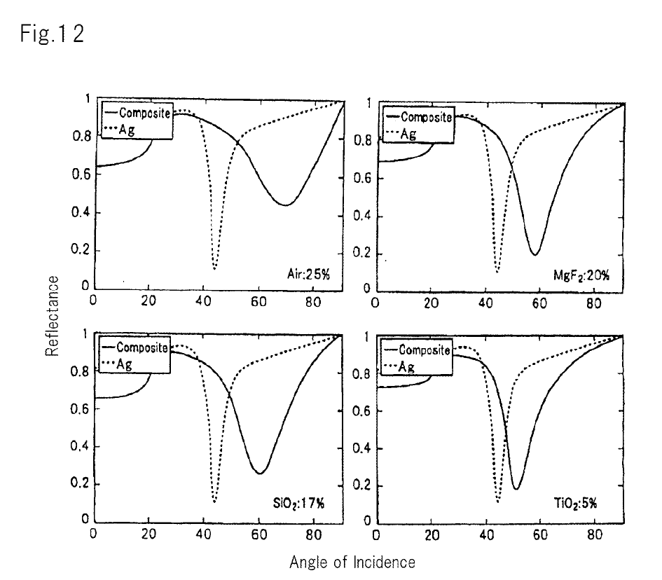

FIG. 12 shows the resonance angle of an optical element for an emission wavelength of 530 nm when the thickness of the plasmon excitation layer shown in FIG. 7 was made 50 nm. As the optical element, an example was used in which SiO₂ as the dielectric layer, the plasmon excitation layer shown in FIG. 7, and TiO₂ were laminated on quantum dots, and the figure shows the results obtained when light was irradiated into the plasmon excitation layer via the TiO₂. The plasmon excitation layer was a composite of Ag and a dielectric having a thickness of 50 nm. The horizontal axis shows the angle of incidence and the vertical axis shows the reflectance. From FIG. 12 it can be seen that a composite of Ag and a dielectric is more appropriate than simple Ag as the plasmon excitation layer at a wavelength that corresponds to green in the visible light band. It can further be seen that the amount of shift of the resonant condition with respect to the added amount is smaller for a dielectric having a low dielectric constant, i.e., that fabrication is facilitated with dielectrics having a lower dielectric constant.

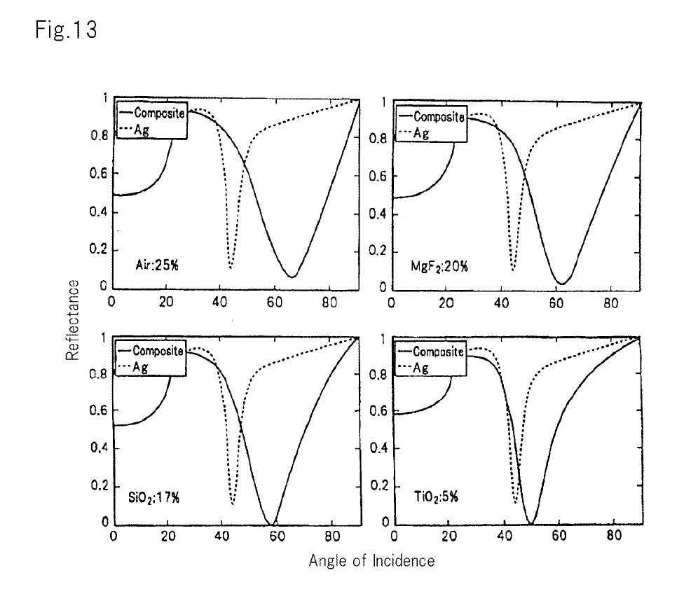

FIG. 13 shows the resonance angle of an optical element for an emission wavelength of 530 nm when the thickness of the plasmon excitation layer shown in FIG. 7 was made 40 nm. As the optical element, an element was used in which SiO₂ as a dielectric layer, the plasmon excitation layer shown in FIG. 7, and TiO₂ were laminated on quantum dots, and the figure shows the results obtained when light was irradiated into the plasmon excitation layer via the TiO₂. The plasmon excitation layer was a composite of Ag and a dielectric with a thickness of 40 nm. The horizontal axis shows the angle of incidence and the vertical axis shows reflectance. A comparison of FIG. 12 and FIG. 13 shows that reflectance dropped lower under the conditions of FIG. 13 than under the conditions of FIG. 12. In other words, changing the thickness of the plasmon excitation layer led to improved extraction efficiency.

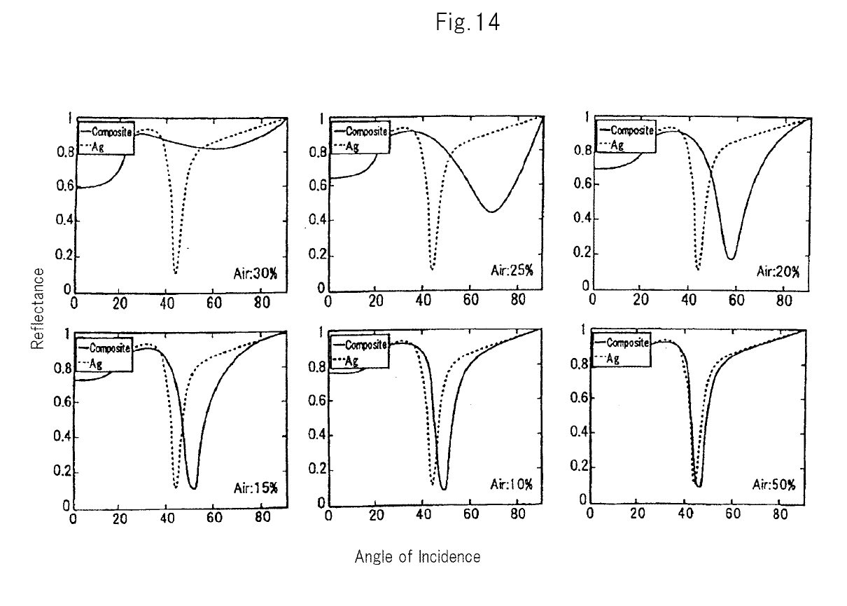

FIG. 14 shows the resonance angle of an optical element for an emission wavelength of 530 when the fraction of the dielectric content is varied in the plasmon excitation layer shown in FIG. 7. As the optical element, an element was used in which SiO₂ as a dielectric layer, the plasmon excitation layer shown in FIG. 7, and TiO₂ were laminated on quantum dots, and the figure shows the results obtained when light was irradiated into the plasmon excitation layer via the TiO₂. The plasmon excitation layer was a composite of Ag and air. The horizontal axis shows the angle of incidence and the vertical axis shows reflectance. As can be understood from FIG. 14, the resonance angle shifts toward higher angles corresponding to increase in the fraction of the dielectric.

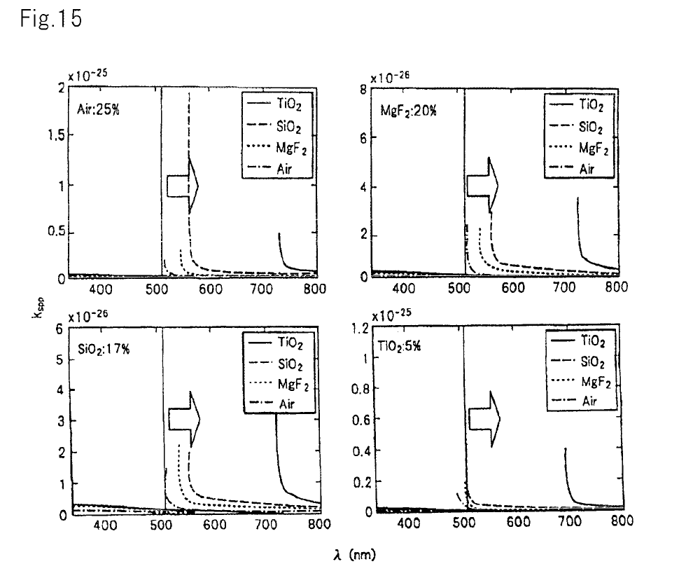

FIG. 15 shows the long wavelength change of the resonance wavelength of an optical element when Ag is used as the metal of the plasmon excitation layer shown in FIG. 7. As the optical element, an element was used in which the dielectric layer shown in the figure, the plasmon excitation layer shown in FIG. 7, and TiO₂ were laminated on quantum dots.

The figure shows the results obtained when a composite of Ag and a dielectric were used as the plasmon excitation layer and when excitation light was irradiated into the plasmon excitation layer via the TiO₂. In FIG. 15, the upper left graph shows a case in which the air content was 25%, the upper right graph shows a case in which the MgF₂ content was 20%, the lower left graph shows a case in which the SiO₂ content was 17%, and the lower right graphs shows a case in which the content of TiO₂ was 5%. The horizontal axis shows wavelength and the vertical axis shows wave number. From FIG. 15, it can be seen that for a dielectric of low dielectric constant, the amount of shift of the resonant condition with respect to the amount of additive is smaller and the permissible range is greater, i.e., that fabrication is facilitated by a dielectric with low dielectric constant.

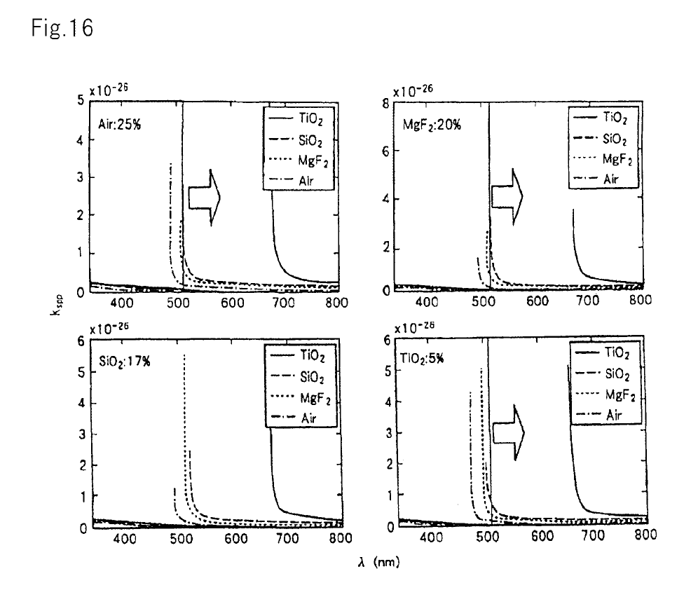

FIG. 16 shows the long wavelength change of the resonance wavelength of an optical element when Au is used as the metal of the plasmon excitation layer shown in FIG. 7. As the optical element, an element was used in which the dielectric layer shown in the figure, the plasmon excitation layer shown in FIG. 7, and TiO₂ were laminated on quantum dots.

The figure shows the results when the plasmon excitation layer was made a composite of Au and a dielectric and when excitation light was irradiated into the plasmon excitation layer via the TiO₂. In FIG. 15, the upper left graph is for a case in which the air content was 25%, the upper right graph is for a case in which the MgF₂ content was 20%, the lower left graph is for a case in which the SiO₂ content was 17%, and the lower right graph is for a case in which the TiO₂ content was 5%. The horizontal axis shows the wavelength and the vertical axis shows the wave number. From FIG. 16, it can be seen that for a dielectric having a lower dielectric constant, the amount of shift of the resonant condition with respect to the added amount is smaller and the permissible range is greater, i.e., that fabrication is facilitated by a dielectric having a lower dielectric constant.

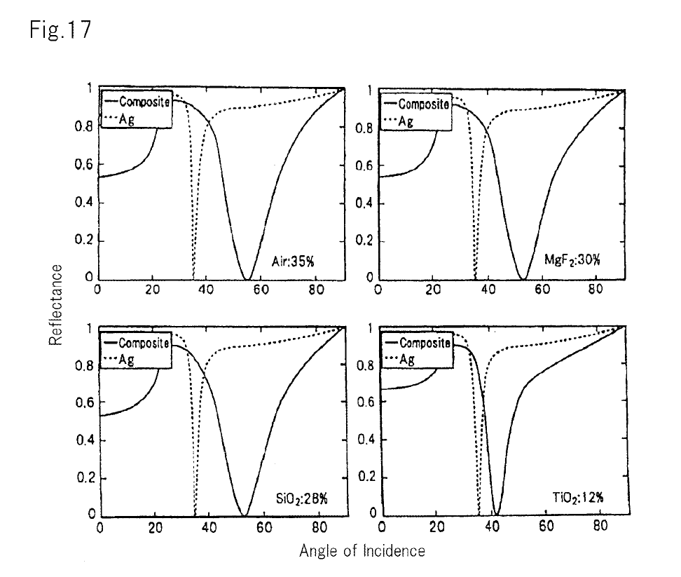

FIG. 17 shows the resonance angle of an optical element for an emission wavelength of 630 nm when Ag is used as the metal of the plasmon excitation layer shown in FIG. 7. As the optical element, an element was used in which SiO₂ as the dielectric layer, the plasmon excitation layer shown in FIG. 7, and TiO₂ were laminated on quantum dots, and the graphs show the results obtained when light was irradiated into the plasmon excitation layer via the TiO₂. A composite of Ag and a dielectric was used as the plasmon excitation layer. The horizontal axis shows the angle of incidence, and the vertical axis shows reflectance. As can be seen from FIG. 17, a composite of Ag and a dielectric is more suitable as the plasmon excitation layer than simple Ag at wavelengths that correspond to red in the visible light band. It can be further seen that the amount of shift of the resonant condition with respect to the added amount is smaller for a dielectric having a low dielectric constant, i.e., that fabrication is facilitated with a dielectric of low dielectric constant.

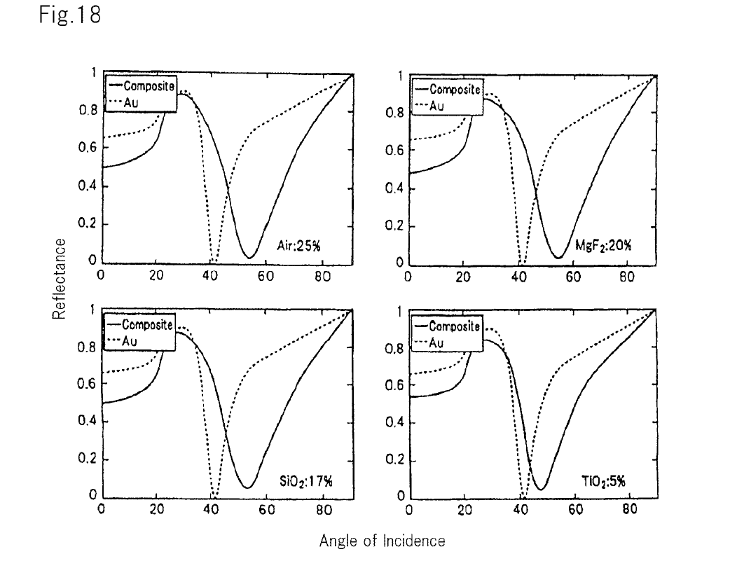

FIG. 18 shows the resonance angle of an optical element for an emission wavelength of 630 nm when Au is used as the metal of the plasmon excitation layer shown in FIG. 7. As the optical element, an element was used in which SiO₂ as a dielectric layer, the plasmon excitation layer shown in FIG. 7, and TiO₂ were laminated on quantum dots, and the graphs show the results obtained when light was irradiated into the plasmon excitation layer via the TiO₂. A composite of Au and a dielectric was used as the plasmon excitation layer. The horizontal axis shows the angle of incidence, and the vertical axis shows reflectance. From FIG. 18, it can be seen that a composite of Au and a dielectric is more suitable as the plasmon excitation layer than simple Ag at wavelengths that correspond to red in the visible light band. It can also be seen that the amount of shift of the resonant condition with respect to the added amount is smaller and the permissible range is greater for a dielectric having a low dielectric constant, i.e., that fabrication is facilitated by a dielectric having low dielectric constant.

Based on the foregoing explanation, a composite of Ag or Au and a dielectric is more suitable as the plasmon excitation layer than simple Ag at wavelengths that correspond to red in the visible light band.

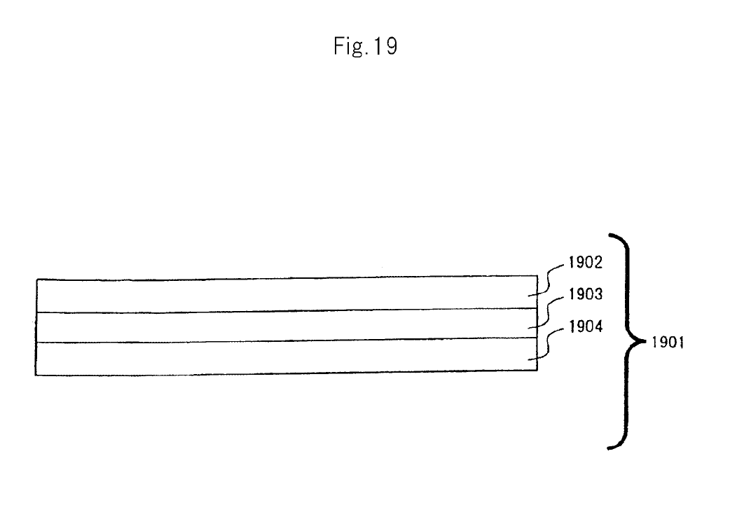

FIG. 19 is a sectional view showing the configuration of another exemplary embodiment of the plasmon excitation layer that is the principal part of the optical element according to the present invention.

Plasmon excitation layer 1901 according to the present exemplary embodiment is a multilayer film composed of a metal and a dielectric, and more specifically, is a construction in which dielectric 1903 is interposed between metal 1902 and 1904. A composite composed of metal and a dielectric may be used in place of the metal. The total thickness of the metal or the composite that is composed of metal and a dielectric contained in plasmon excitation layer 1901 is preferably less than 100 nm. Here, the distance between metal 1902 and metal 1904 is preferably equal to or less than the smaller effective interactive distance of the effective interactive distance of surface plasmons that is calculated using Equation (4) with ∈_{eff} of Equation (2) as the dielectric constant of dielectric 1903 with respect to the interface of metal 1902 and dielectric 1903 and the effective interactive distance of surface plasmons that is calculated using Equation (4) with ∈_{eff} of Equation (2) as the dielectric constant of dielectric 1903 with respect to the interface of metal 1904 and dielectric 1903.

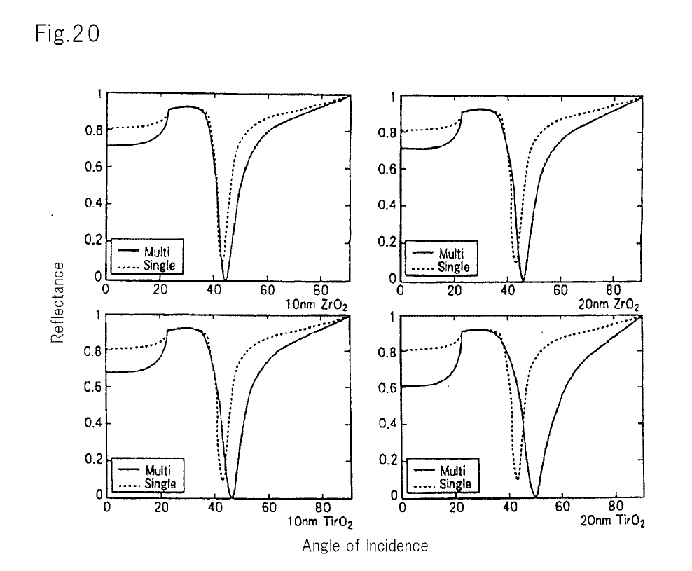

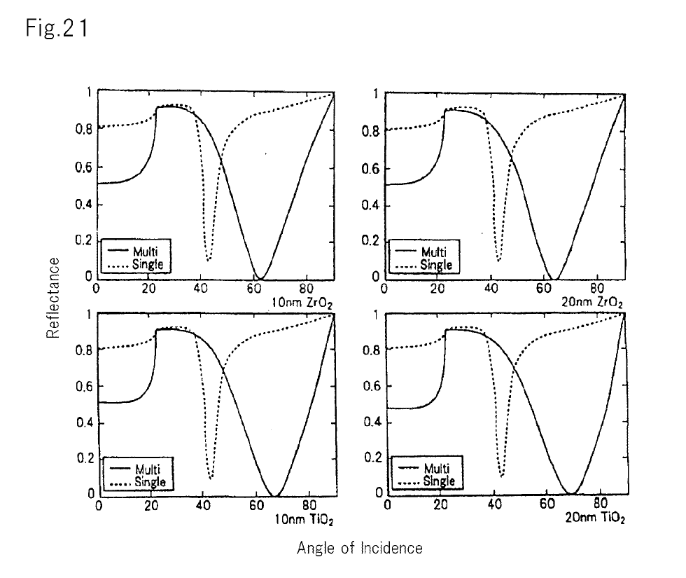

FIG. 20 and FIG. 21 show the reflectance with respect to the angle of incidence when light of a wavelength of 530 nm is irradiated into an optical element that uses the plasmon excitation layer shown in FIG. 19. “Multi” in the legends indicates cases in which a composite composed of a metal and a dielectric was used as the plasmon excitation layer, and “Single” indicates cases in which a metal alone was used as the plasmon excitation layer. Explanation of similar legends is omitted hereinbelow. By way of comparison, all cases are shown with a single-layer film of Ag (Single). As the optical element, an element was used in which ZrO₂ as a dielectric layer, the plasmon excitation layer shown in FIG. 19, and TiO₂ were laminated on quantum dots, and the graphs show the results obtained when excitation light was irradiated into the plasmon excitation layer via the TiO₂.

As the plasmon excitation layer, a multilayer film of Ag/dielectric/Ag was used in the example shown in FIG. 20 and a multilayer film of Ag-composite/dielectric/Ag-composite was used in the example shown in FIG. 21.

In both of FIG. 20 and FIG. 21, the upper left graph shows a case in which the dielectric is ZrO₂ having a thickness of 10 nm, the upper right graphs shows a case in which the dielectric is ZrO₂ having a thickness of 20 nm, the lower left graph shows a case in which the dielectric is TiO₂ having a thickness of 10 nm, and the lower right graph shows a case in which the dielectric is TiO₂ having a thickness of 20 nm.

The dielectric constant of ZrO₂ is 4.0, and the dielectric constant of TiO₂ is at least 6.0. From FIG. 20 and FIG. 21, it can be seen that the dielectric having the higher dielectric constant can raise the coupling efficiency while maintaining the extraction efficiency.

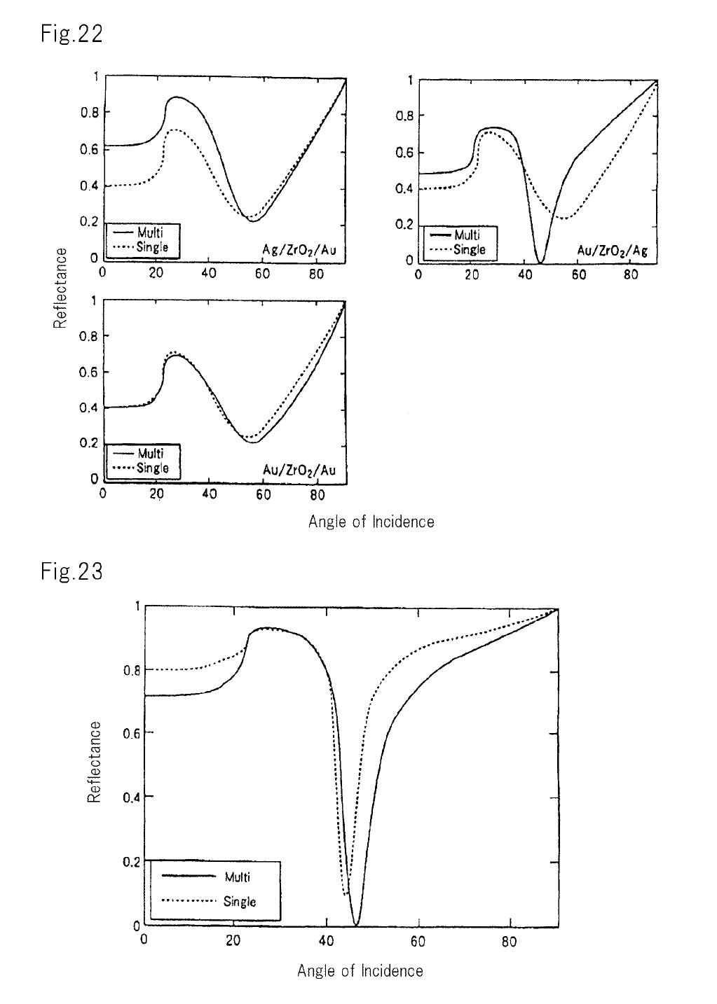

FIG. 22 shows the reflectance with respect to the angle of incidence when light having a wavelength of 530 nm is irradiated into an optical element that contains different types of metal as the plasmon excitation layer shown in FIG. 19. As a comparison, each case is shown together with a single-layer film (Single) of Ag. As the optical element, an element is used in which ZrO₂ as a dielectric layer, the plasmon excitation layer shown in FIG. 19, and TiO₂ are laminated on quantum dots, and the figure shows the results obtained when light is irradiated into the plasmon excitation layer via the TiO₂.

The plasmon excitation layer is Ag/ZrO₂/Au for the case shown in the upper left graph, Au/ZrO₂/Ag for the case shown in the upper right graph, and Au/ZrO₂/Au for the case shown in the lower left graph. As shown in FIG. 22, different types of metals may be used for the metals used in the metal-dielectric multilayer film.

FIG. 23 shows the reflectance with respect to the angle of incidence when light having a wavelength of 530 nm is irradiated into an optical element that uses a total of seven metal-dielectric multilayer films as the plasmon excitation layer shown in FIG. 19. For comparison, the results are also shown together with an Ag single-layer film (Single). As the optical element, an element was used in which ZrO₂ as the dielectric layer, the plasmon excitation layer shown in FIG. 19, and TiO₂ are laminated on quantum dots. As the plasmon excitation layer, a dielectric having a thickness of 5 nm is sandwiched between four layers of metal each having a thickness of 10 nm. As shown in FIG. 23, the metal and dielectric may be repeated a plurality of layers, and the thickness of each of the layers may differ.

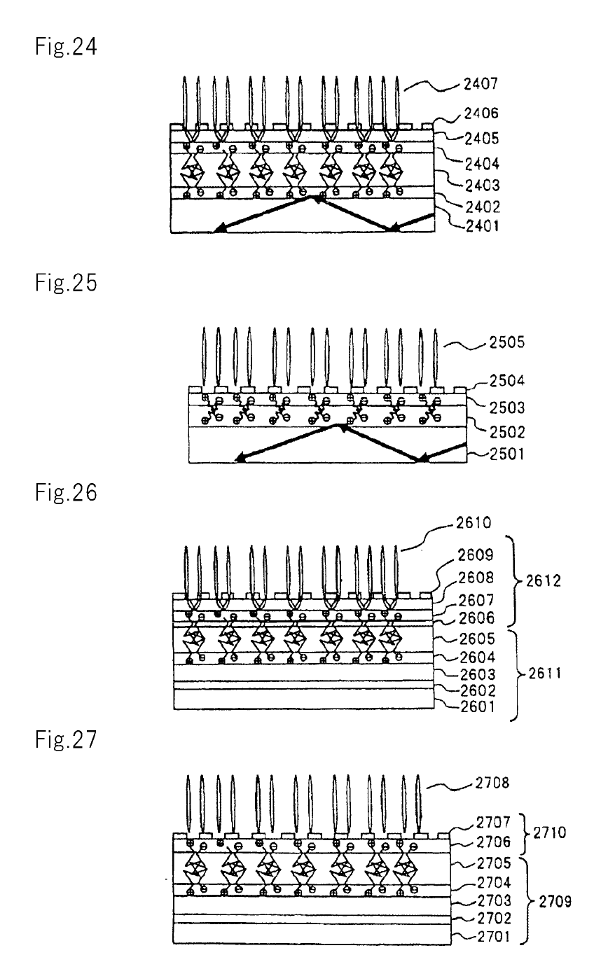

FIG. 24 is a sectional view showing the configuration of an exemplary embodiment of the optical element according to the present invention.

The present exemplary embodiment is provided with: carrier generation layer 2402 that is provided on light guide body 2401 and in which carriers are generated by a portion of the light that is incident to light guide body 2401; plasmon excitation layer 2404 that is laminated on this carrier generation layer 2402 and that has a plasma frequency that is higher than the frequency of light that is generated when carrier generation layer 2402 is excited by light that passes through light guide body 2401; and wave vector conversion layer 2406 that is laminated on this plasmon excitation layer 2404 and that converts the wave vector of incident light and emits light as the emission layer.

In addition, plasmon excitation layer 2406 is sandwiched between two layers having dielectricity. As the two layers having dielectricity, high-dielectric constant layer 2405 that is provided sandwiched between plasmon excitation layer 2404 and wave vector conversion layer 2406 and low-dielectric constant layer 2403 that has a dielectric constant lower than high-dielectric constant layer 2405 and that is provided sandwiched between carrier generation layer 2402 and plasmon excitation layer 2404 are provided.

The optical element in the present exemplary embodiment is of a configuration such that the effective dielectric constant of the incident-side portion that includes all of the construction that is laminated on the light guide body 2401-side of plasmon excitation layer 2404 (hereinbelow referred to as simply the “incident-side portion”) is lower than the effective dielectric constant of the emission-side portion that includes all of the construction that is laminated on the wave vector conversion layer 2406-side of plasmon excitation layer 2404 and the medium that is in contact with wave vector conversion layer 2406 (hereinbelow referred to as simply “emission-side portion”). Light guide body 2401 is included with the entire construction that is laminated on the light guide body 2401-side of plasmon excitation layer 2404. Wave vector conversion layer 2406 is included in the entire construction that is laminated on the wave vector conversion layer 2406-side of plasmon excitation layer 2404.

In other words, in the present exemplary embodiment, the effective dielectric constant of the incident-side portion that includes light guide body 2401 and carrier generation layer 2402 with respect to plasmon excitation layer 2404 is lower than the effective dielectric constant of the emission-side portion that includes wave vector conversion layer 2406 and the medium with respect to plasmon excitation layer 2404.

To state in greater detail, the real part of the complex effective dielectric constant of the incident-side portion of plasmon excitation layer 2404 is set lower than the real part of the complex effective dielectric constant of the emission-side portion (the side of wave vector conversion layer 2406) of plasmon excitation layer 2404.

Here, complex effective dielectric constant ∈_{eff} is determined based on the dielectric constant distribution of the incident-side portion or emission-side portion and the distribution of surface plasmons with respect to a direction perpendicular to the interface of plasmon excitation layer 2404 and is expressed by:

$$\begin{matrix}[ Equation 3 ] & \\ {ɛ}_{ff} = {( \frac{\int {\int }_{D} \int Re [ \sqrt{ɛ ( ω , x , y , z )} ] exp ( 2 j {k}_{spp , z} z )}{\int {\int }_{D} \int exp ( 2 j {k}_{spp , z} z )} )}^{2} & Equation ( 1 )\end{matrix}$$

where the x-axis and y-axis are directions parallel to the interface of plasmon excitation layer 2404, the z-axis is a direction perpendicular to the interface of plasmon excitation layer 2404, w is the angular frequency of light that is emitted from carrier generation layer 6, ∈(ω, x, y, z) is the dielectric constant distribution on the incident-side portion and emission-side portion with respect to plasmon excitation layer 2404, k_{spp,z} is the z-component of the wave number of surface plasmons, and j is the imaginary number unit.

Here, integral range D is the three-dimensional coordinate range of the incident-side portion or emission-side portion with respect to plasmon excitation layer 2404. In other words, the range in the x-axis and y-axis directions in this integral range D is a range that does not include the medium as far as the outer peripheral surface of the construction that is included in the incident-side portion or the outer peripheral surface of the construction that is included in the emission-side portion, and is a range up to the outer edge in a plane that is parallel to the interface of plasmon excitation layer 2404. In addition, the range in the z-axis direction in integral range D is the range of the incident-side portion or emission-side portion (that includes the medium). Regarding the range in the z-axis direction in integral range D, taking the interface of plasmon excitation layer 2404 and a layer having dielectricity that is adjacent to plasmon excitation layer 2404 as the position at which z=0, the range extends from this interface to an infinite distance on the side of the above-described adjacent layer of plasmon excitation layer 2404, and the direction of increasing distance from this interface is taken as the (+) z-direction in Equation (1). If an uneven surface is formed on the surface of plasmon excitation layer 2404, the effective dielectric constant is found by using Equation (1) if the origin of the z coordinate is moved along the uneven surface of plasmon excitation layer 2404. If there is a material having optical anisotropy in the calculation range of the effective dielectric constant, ∈(ω, x, y, z) is vector and has a different value for each radius vector perpendicular to the z-axis. In other words, effective dielectric constants of an incident-side portion and emission-side portion exist for each radius vector that is perpendicular to the z-axis. The value of ∈(ω, x, y, z) at this time is taken as the dielectric constant for a direction parallel to a radius vector that is perpendicular to the z-axis. As a result, all phenomena relating to effective dielectric constants such as k_{spp,z}, kₛₚₚ, and d_{eff} (to be described) have different values for each radius vector that is perpendicular to the z-axis.

Effective dielectric constant ∈_{eff} may be calculated using the following equation. However, the use of Equation (1) is particularly preferable.

$$\begin{matrix}[ Equation 4 ] & \\ {ɛ}_{eff} = \frac{\int {\int }_{D} \int Re [ ɛ ( ω , x , y , z ) ] exp ( 2 j {k}_{spp , z} z )}{\int {\int }_{D} \int exp ( 2 j {k}_{spp , z} z )} & Equation ( 1.1 )\end{matrix}$$

In addition, assuming that ∈ₘₑₜₐₗ is the dielectric constant of plasmon excitation layer 8 and k₀ is the wave number of light in a vacuum, the z component k_{spp,z} of the wave number of surface plasmons and the x and y components kₛₚₚ of the wave number of surface plasmons are expressed by:

$$\begin{matrix}[ Equation 5 ] & \\ {k}_{spp , z} = \sqrt{{ɛ}_{eff} {k}_{0}^{2} - {k}_{spp}^{2}} & Equation ( 2 ) \\ [ Equation 6 ] & \\ {k}_{spp} = {k}_{0} Re [ \sqrt{\frac{{ɛ}_{eff} {ɛ}_{metal}}{{ɛ}_{eff} + {ɛ}_{metal}}} ] & Equation ( 3 )\end{matrix}$$

Here, Re[ ] represents taking of the real part in the brackets [ ].

Accordingly, the complex effective dielectric constant ∈_{effin} of the incident-side portion and the complex effective dielectric constant ∈_{effout} of the emission-side portion with respect to plasmon excitation layer 2404 are each found by using Equation (1), Equation (2), and Equation (3) and then calculating by substituting the incident-side portion dielectric constant distribution ∈ᵢₙ(ω, x, y, z) of plasmon excitation layer 8 and emission-side portion dielectric constant distribution ∈ₒᵤₜ(ω, x, y, z) of plasmon excitation layer 2404 as ∈(ω, x, y, z). In actuality, the complex effective dielectric constant ∈_{eff} can be easily found by assigning an appropriate initial value as complex effective dielectric constant ∈_{eff} and then repeatedly calculating Equation (1), Equation (2), and Equation (3). When the dielectric constant of the layer that is in contact with plasmon excitation layer 2404 is extremely high, the z-component k_{spp,z} of the wave number of the surface plasmon at this interface is a real number. This state corresponds to a case in which surface plasmons are not generated in this interface. As a result, the dielectric constant of a layer that makes contact with plasmon excitation layer 2404 corresponds to the effective dielectric constant in this case.

Assuming that the effective interactive distance of surface plasmons is the distance at which the intensity of surface plasmons is e⁻², the effective interactive distance d_{eff} of surface plasmons is expressed by:

$$\begin{matrix}[ Equation 7 ] & \\ {d}_{eff} = Im [ \frac{1}{{k}_{spp , z}} ] & Equation ( 4 )\end{matrix}$$

Low-dielectric constant layer 2403 is a layer in which the dielectric constant is lower than that of high-dielectric constant layer 2405. The complex dielectric constant of low-dielectric constant layer 2403 is assumed to be ∈ₗ(λ₀), the real part of this value is assumed to be ∈ₗᵣ(λ₀), and the imaginary part is assumed to be ∈ₗᵢ(λ₀). In addition, if the complex dielectric constant of high-dielectric constant layer 2405 is ∈ₕ(λ₀), the real part is ∈ₕᵣ(λ₀), and the imaginary part is ∈ₕᵢ(λ₀), then the relation 1≦∈ₗᵣ(λ₀)<∈ₕᵣ(λ₀) is satisfied. In addition, λ₀ is the wavelength in a vacuum of the incident light to the dielectric constant layer.

However, even when the dielectric constant of low-dielectric constant layer 2403 is higher than the dielectric constant of high-dielectric constant layer 2405, the optical element will operate if the real part of the effective dielectric constant of the low-dielectric constant layer 2403-side of plasmon excitation layer 2404 is lower than the real part of the effective dielectric constant of the high-dielectric constant layer 2405-side of plasmon excitation layer 2404. In other words, the dielectric constants of low-dielectric constant layer 2403 and high-dielectric constant layer 2405 are permitted a range in which the real part of the effective dielectric constant of the emission side of plasmon excitation layer 2404 is kept higher than the real part of the effective dielectric constant of the incident side. If the effective dielectric constants of the incident side and emission side satisfy the above-described condition, the dielectric constant of low-dielectric constant layer 2403 may be higher than the dielectric constant of the high-dielectric constant layer 2405. In addition, if the effective dielectric constant of the incident-side portion is lower than the effective dielectric constant of the emission-side portion even without high-dielectric constant layer 2405 and low-dielectric constant layer 2403, then high-dielectric constant layer 2405 and low-dielectric constant layer 2403 are not indispensible constituent elements for the operation of the present exemplary embodiment.

The imaginary part of the complex dielectric constant in the emission frequency is preferably as low as possible in any layer that includes light guide body 2401 or in a medium that is in contact with wave vector conversion layer 2406. Making the imaginary part of the complex dielectric constant as low as possible facilitates the occurrence of plasmon coupling and enables a reduction of optical loss.

Although light guide body 2401 is formed in plate shape in the present exemplary embodiment, the shape of light guide body 2401 is not limited to a rectangular parallelepiped. A structure such as micro-prisms that controls light distribution characteristics may be provided inside light guide body 2401. The surface on the carrier generation layer 2402-side of light guide body 2401 and all surfaces on light guide body 2401 other than the surface that is used for irradiating light for generating carriers in carrier generation layer 2402 are preferably subjected to a process using a reflective material or dielectric multilayer film such that excitation light is not emitted from surfaces other than the light-emission part of the light guide body 2401. In addition, light guide body 2401 is not an indispensible constituent element, and in place of a light guide body, the light-emitting surface of a light-emitting element may be arranged in proximity to carrier generation layer 2402. Still further, a configuration may be adopted in which the light-emitting element is disposed separated by a gap and light from the light-emitting element irradiated upon carrier generation layer 2402.

Examples of materials that are used as carrier generation layer 2402 include: organic fluorescent materials such as Rhodamine 6G or sulforhodamine 101, quantum dot fluorescent materials such as CdSe or CdSe/ZnS quantum dots, inorganic materials (semiconductors) such as GaN or GaAs, and organic materials (semiconductor materials) such as (thiophene/phenylene) co-oligomer or Alq3. When a fluorescent material is used, materials that emit fluorescent light having the same emission wavelength or a plurality of different wavelengths may be mixed in carrier generation layer 2402. The thickness of carrier generation layer 2402 is preferably no greater than 1 μm.

Examples of the material that is preferably used for low-dielectric constant layer 2403 include a SiO₂ nano-rod array film, a thin film, or a porous film of SiO₂, AlF₃, MgF₂, Na₃AlF₆, NaF, LiF, CaF₂, BaF₂, or a low dielectric constant plastic. The thickness of low-dielectric constant layer 2403 is ideally within 5 nm-50 nm.

Examples of the high dielectric constant material that is preferably used for high-dielectric constant layer 2405 include diamond, TiO₂, CeO₂, Ta₂O₅, ZrO₂, Sb₂O₃, HfO₂, La₂O₃, NdO₃, Y₂O₃, ZnO, and Nb₂O₅.

Plasmon excitation layer 2404 accords with the metal-dielectric composite shown in FIG. 7 or the multilayer film composed of metal and a dielectric shown in FIG. 19, and is formed by a material having a plasma frequency that is higher than the frequency (emission frequency) of light that is generated when carrier generation layer 2402 alone is excited by light. In other words, plasmon excitation layer 2404 has a negative dielectric constant at an emission frequency that is generated when carrier generation layer 2402 alone is excited by light.

Examples that can be offered as materials used as the metal material of plasmon excitation layer 2404 include gold, silver, copper, platinum, palladium, rhodium, osmium, ruthenium, iridium, iron, tin, zinc, cobalt, nickel, chromium, titanium, tantalum, tungsten, indium, aluminum, or an alloy of these metals. Of these metals, gold, silver, copper, platinum, aluminum and an alloy that takes these metals as a principal component are preferable as the material of plasmon excitation layer 8, and gold, silver, aluminum and an alloy that takes these metals as a principal component are particularly preferable. As the dielectric material of plasmon excitation layer 2404, a material having a dielectric constant that is as low as possible is preferable, and examples of the materials that are preferably used as the low dielectric constant material include Air, SiO₂, AlF₃, MgF₂, Na₃AlF₆, NaF, LiF, CaF₂, BaF₂, and low-dielectric constant plastic.

The thickness of plasmon excitation layer 2404 is preferably formed no greater than 200 nm, and is particularly preferably formed in the order of from 10 nm to 100 nm. The distance from the interface of high-dielectric constant layer 2405 and plasmon excitation layer 2404 to the interface of low-dielectric constant layer 2403 and carrier generation layer 2402 is preferably formed to be no greater than 500 nm. This distance corresponds to the distance at which plasmon coupling occurs between carrier generation layer 2402 and plasmon excitation layer 2404.

Wave vector conversion layer 2406 is an emission layer for emitting light from the optical element by converting the wave vector of incident light that is irradiated into this wave vector conversion layer 2406 to extract light from high-dielectric constant layer 2405. In other words, wave vector conversion layer 2406 converts the emission angle of light from high-dielectric constant layer 2405 to a predetermined angle and emits the light from the optical element. Essentially, wave vector conversion layer 2406 plays the role of emitting radiation 2407 from the optical element so as to be substantially orthogonal to the interface with high-dielectric constant layer 2405. If the high-dielectric constant layer 2405-side effective dielectric constant is ∈_{effout}, the emission angle θₒᵤₜ of light that is emitted from high-dielectric constant layer 2405 is expressed by:

$$\begin{matrix}[ Equation 8 ] & \\ {θ}_{out} = {sin}^{- 1} ( \frac{{k}_{spp}}{\sqrt{{ɛ}_{effout}} {k}_{0}} ) & Equation ( 5 )\end{matrix}$$

Because only wave numbers in the vicinity of the wave vector found by Equation (3) exist at the interface of plasmon excitation layer 2404 and high-dielectric constant layer 2405, the angular distribution of the emission angle of light that is emitted from high-dielectric constant layer 2405 and that is found by Equation (5) is also narrowed. The light that is emitted from one point of high-dielectric constant layer 2405 has a ring-shaped intensity distribution that spreads concentrically as it propagates.

Examples of wave vector conversion layer 2406 include forms that employ a periodic structure in which a surface-relief grating and photonic crystal are representative, a quasi-periodic structure (a textured structure that is larger than the wavelength of light from high-dielectric constant layer 9) or a quasi-crystal structure, a surface structure in which a rough surface is formed, a hologram, or micro-lens array. A quasi-periodic structure refers to an incomplete periodic structure in which a portion of the periodic structure is missing. Of these examples, a form that employs a periodic structure as represented by a photonic crystal, a quasi-periodic structure, a quasi-crystal structure, and a micro lens array are preferable. The reason for this preference is not only because these forms increase the light extraction efficiency but also because they enable control of directivity. When a photonic crystal is employed, a form is preferably adopted in which the crystalline structure has a triangular lattice structure. A structure in which protrusions are provided on a plate-shaped base may also be used as wave vector conversion layer 2406. In addition, wave vector conversion layer 2406 may be formed from a material that differs from that of high-dielectric constant layer 2405.

FIG. 25 is a sectional view showing the configuration of another exemplary embodiment of the optical element according to the present invention.

The present exemplary embodiment is provided with: carrier generation layer 2502 that is provided on light guide body 2501 and in which carrier is generated by a portion of the light that is irradiated from light guide body 2501; plasmon excitation layer 2503 that is laminated on this carrier generation layer 2502 and that has a higher plasma frequency than the frequency of light that is generated when carrier generation layer 2502 is excited by light; and wave vector conversion layer 2504 that is laminated on this plasmon excitation layer 2503 as an emission layer and that converts the wave vector of surface plasmons that are generated by plasmon excitation layer 2503 to light of a predetermined emission angle and emits light. Plasmon excitation layer 2503 of the present exemplary embodiment is arranged directly over carrier generation layer 2502, but a dielectric layer having a thickness of 5-50 nm is preferably inserted between plasmon excitation layer 2503 and carrier generation layer 2502. This dielectric layer is provided for increasing the proportion of the carriers that are generated in carrier generation layer 2502 that are used for exciting surface plasmons in plasmon excitation layer 2503. In addition, wave vector conversion layer 2504 is arranged directly over plasmon excitation layer 2503, but a configuration may also be adopted in which a dielectric layer having a thickness less than 1 μm is provided between wave vector conversion layer 2504 and plasmon excitation layer 2503.

Plasmon excitation layer 2503 is sandwiched between two layers having dielectricity. In the present exemplary embodiment, these two layers correspond to carrier generation layer 2502 and wave vector conversion layer 2504. The optical element in the present exemplary embodiment is configured such that the effective dielectric constant of the incident-side portion that includes the entire construction that is laminated on the light guide body 2501-side of plasmon excitation layer 2503 (hereinbelow referred to as simply the “incident-side portion”) is higher than the effective dielectric constant of the emission-side portion that includes the entire construction that is laminated on the wave vector conversion layer 2504-side of plasmon excitation layer 2503 and the medium that is in contact with wave vector conversion layer 2504 (hereinbelow referred to as simply the “emission-side portion”). The entire construction that is laminated on the light guide body 2501-side of plasmon excitation layer 2503 includes light guide body 2501. The entire construction that is laminated on the wave vector conversion layer 2504-side of plasmon excitation layer 2503 includes wave vector conversion layer 2504.

In other words, in the present exemplary embodiment, the effective dielectric constant of the incident-side portion that includes light guide body 2501 and carrier generation layer 2502 with respect to plasmon excitation layer 2503 is higher than the effective dielectric constant of the emission-side portion that includes wave vector conversion layer 2504 and the medium with respect to plasmon excitation layer 2503.

To state in greater detail, the real part of the complex effective dielectric constant of the incident-side portion of plasmon excitation layer 2504 is set higher than the real part of the complex effective dielectric constant of the emission-side portion (the wave vector conversion layer 2505-side) of plasmon excitation layer 2504.

If the x-axis and y-axis are directions parallel to the interface of plasmon excitation layer 2503, the z-axis is a direction perpendicular to the interface of plasmon excitation layer 2503, ω is the angular frequency of light that is emitted from carrier generation layer 2502, ∈(ω, x, y, z) is the dielectric constant distribution of the dielectric in the incident-side portion and emission-side portion with respect to plasmon excitation layer 2503, k_{spp,z} is the z-component of the wave number of surface plasmons, and j is the imaginary number unit, the complex effective dielectric constant ∈_{eff} is represented by Equation (1). Here, the integral range D is a three-dimensional coordinate range of the incident-side portion or emission-side portion with respect to plasmon excitation layer 17. In other words, the ranges of the x-axis and y-axis directions in this integral range D are ranges that do not include the medium as far as the outer peripheral surface of the construction included in the incident-side portion or the outer peripheral surface of the construction that is included in the emission-side portion, and are ranges as far as the outer edge within a plane that is parallel to the interface of plasmon excitation layer 2503. In addition, the range in the z-axis direction in integral range D is the range of the incident-side portion or emission-side portion (including the medium). Regarding the range of the z-axis direction in integral range D, the interface between plasmon excitation layer 2503 and a layer that is contiguous to plasmon excitation layer 2503 and that has dielectricity is taken as the position at which z=0, and the range in the z-axis direction is the range from this interface to an infinite distance on the side of the above-described contiguous layer of plasmon excitation layer 2503, the direction of increasing distance from this interface being the (+) z direction in Equation (1). If an uneven surface is formed on the surface of plasmon excitation layer 2503, the effective dielectric constant is found by using Equation (1) if the origin of the z coordinates is moved along the unevenness of plasmon excitation layer 2503.

In addition, if ∈ₘₑₜₐₗ is the real part of the dielectric constant of plasmon excitation layer 17 and k₀ is the wave number of light in a vacuum, the z component k_{spp,z} of the wave number of surface plasmons and the x and y component kₛₚₚ of the wave number of surface plasmons are expressed by Equation (2) and Equation (3).

Accordingly, the complex effective dielectric constant ∈_{effin} of the incident-side portion with respect to plasmon excitation layer 2503 and the complex effective dielectric constant ∈_{effout} of the emission-side portion of plasmon excitation layer 2503 are each found by calculation by using Equation (1), Equation (2), and Equation (3) and replacing each of the dielectric constant distribution ∈ᵢₙ(ω, x, y, z) of the incident-side portion of plasmon excitation layer 2503 and the dielectric constant distribution ∈ₒᵤₜ(ω, x, y, z) of the emission-side portion of plasmon excitation layer 2503, respectively, with ∈(ω, x, y, z). In actuality, the complex effective dielectric constant ∈_{eff} can be easily found by assigning an appropriate initial value as complex effective dielectric constant ∈_{eff} and then repeatedly calculating Equation (1), Equation (2), and Equation (3). When the real part of the dielectric constant of the layer that is in contact with plasmon excitation layer 2503 is extremely large, the z-component K_{spp,z} of the wave number of surface plasmons at this interface becomes a real number. This case corresponds to a case in which surface plasmons are not generated at the interface. As a result, the dielectric constant of the layer that is in contact with plasmon excitation layer 2503 corresponds to the effective dielectric constant in this case.

If the effective interactive distance of surface plasmons is the distance at which the intensity of surface plasmons becomes e⁻², the effective interactive distance d_{eff} of the surface plasmons is expressed by Equation (4).

In any layer that includes light guide body 2501 or the medium that is in contact with wave vector conversion layer 2504, the imaginary part of the complex dielectric constant at the emission frequency is preferably as low as possible. Making the imaginary part of the complex dielectric constant as low as possible facilitates generation of plasmon coupling and enables a reduction of optical loss.

In the present exemplary embodiment, light guide body 2501 is formed as a plate shape, but the shape of light guide body 2501 is not limited to a rectangular parallelepiped. A structure that controls the light distribution characteristic such as micro-prisms may be provided inside light guide body 2501. All surfaces other than the surface on the carrier generation layer 2502-side of light guide body 2501 and the surface that is used for irradiating light into light guide body 2501 for generating carrier in carrier generation layer 2502 are preferably subjected to a process using a reflective material or a dielectric multilayer film such that excitation light is not emitted from surfaces other than the light-emission part of the light guide body. In addition, light guide body 2401 is not an indispensible constituent element and, in place of the light guide body, the light-emitting surface of a light-emitting element may be arranged in proximity to carrier generation layer 2502. Still further, a configuration may be adopted in which the light-emitting element is arranged separated by a gap and the light from the light-emitting element is irradiated into carrier generation layer 2502.

Materials that are used for carrier generation layer 2502 include: organic fluorescent materials such as Rhodamine 6G or sulforhodamine 101, quantum dot fluorescent materials such as CdSe or CdSe/ZnS quantum dots, inorganic materials (semiconductors) such as GaN or GaAs, or organic materials (semiconductor materials) such as (thiophene/phenylene) co-oligomers or Alq3. When fluorescent materials are used, materials that emit fluorescent light having the same emission wavelength or that have a plurality of different wavelengths may be mixed in carrier generation layer 2502. The thickness of carrier generation layer 2502 is preferably no greater than 1 μm.

Plasmon excitation layer 2503 accords with the metal-dielectric composite shown in FIG. 7 or the multilayer film composed of metal and dielectric shown in FIG. 19 and is formed by materials having a plasma frequency that is higher than the frequency (emission frequency) of light that is generated when carrier generation layer 2502 alone is excited by light. In other words, plasmon excitation layer 2503 has a negative dielectric constant at an emission frequency that is generated when carrier generation layer 2502 alone is excited by light.

Examples that can be offered as materials used as the metal material of plasmon excitation layer 2503 include gold, silver, copper, platinum, palladium, rhodium, osmium, ruthenium, iridium, iron, tin, zinc, cobalt, nickel, chromium, titanium, tantalum, tungsten, indium, aluminum, or an alloy of these metals. Of these metals, gold, silver, copper, platinum, aluminum, and an alloy that takes these metals as principal components are preferable as the material of plasmon excitation layer 17, and gold, silver, aluminum and an alloy that takes these metals as principal components are particularly preferable. The thickness of plasmon excitation layer 17 is preferably formed no greater than 200 nm, and particularly preferably formed in the order of from 10 nm to 100 nm. As the dielectric material of plasmon excitation layer 2503, a material having a dielectric constant that is as low as possible is preferable, and examples of the materials that are preferably used as the low dielectric constant material include Air, SiO₂, AlF₃, MgF₂, Na₃AlF₆, NaF, LiF, CaF₂, BaF₂, and low dielectric constant plastic.

The thickness of plasmon excitation layer 2503 is preferably formed no greater than 200 nm, and is particularly preferably formed on the order of from 10 nm to 100 nm.

Wave vector conversion layer 2504 is an emission layer for emitting light from the optical element and extracts light from the interface of plasmon excitation layer 2503 and wave vector conversion layer 2504 by converting the wave vector of surface plasmons that are excited at the interface of plasmon excitation layer 2503 and wave vector conversion layer 2504. In other words, wave vector conversion layer 2504 converts surface plasmons to light of a predetermined emission angle and emits the light from the optical element. Essentially, wave vector conversion layer 2504 performs the function of emitting radiation 2505 from the optical element such that radiation 2505 is substantially orthogonal to the interface of plasmon excitation layer 2503 and wave vector conversion layer 2504.

Examples of wave vector conversion layer 2504 include forms that employ a periodic structure of which a surface-relief grating and photonic crystal are representative, a quasi-periodic structure, a quasi-crystal structure, a textured construction that is greater than the wavelength of light from the optical element, a surface structure in which a rough surface is formed, a hologram, or micro-lens array. A quasi-periodic structure refers to an incomplete periodic structure in which a portion of the periodic structure is lacking. Of these examples, a form that employs a periodic structure as represented by a photonic crystal, a quasi-periodic structure, a quasi-crystal structure, and a micro-lens array are preferable. The reason for this preference is that not only do these forms increase light extraction efficiency but they also enable control of directivity. When a photonic crystal is employed, a form is preferably adopted in which the crystalline structure has a triangular lattice structure. A structure in which protrusions are provided on a plate-shaped base may also be used as wave vector conversion layer 2504.

In the light that is propagated by the total reflection in light guide body 2501, the reflection conditions break down at the interface of light guide body 2501 and carrier generation layer 2502 and light is irradiated into carrier generation layer 2502. The light that is irradiated into carrier generation layer 2502 generates carriers in carrier generation layer 2502. The generated carriers bring about plasmon coupling with free electrons in plasmon excitation layer 2503. Surface plasmons are excited at the interface of plasmon excitation layer 2503 and wave vector conversion layer 2504 by way of this plasmon coupling, and the excited surface plasmons are diffracted by wave vector conversion layer 2504 to be emitted outside of optical element as radiation 2505.

When the dielectric constant of the interface of plasmon excitation layer 2503 and wave vector conversion layer 2504 is spatially uniform, i.e., a flat surface, surface plasmons that are generated at this interface cannot be extracted. As a result, the provision of wave vector conversion layer 2504 in the present exemplary embodiment enables diffraction of the surface plasmons and extraction of the surface plasmons as light. The light that is emitted from one point of wave vector conversion layer 2504 has a ring-shaped intensity distribution that spreads concentrically with propagation. Assuming that Λ is the pitch of the periodic structure of wave vector conversion layer 2504 and that η_{rad} is the index of refraction of the light-extraction-side of the wave vector conversion layer (i.e., the medium that is in contact with the wave vector conversion layer), the central emission angle θ_{rad} of light that is emitted from wave vector conversion layer 2504 when the emission angle of the greatest intensity is taken as the central emission angle is expressed as:

$$\begin{matrix}[ Equation 9 ] & \\ {θ}_{rad} = {sin}^{- 1} ( \frac{{k}_{spp} - i \frac{2 π}{Λ}}{{n}_{rad} {k}_{0}} ) & Equation ( 6 )\end{matrix}$$

Here, “i” is a positive or negative integer. Because only wave numbers in the vicinity of the wave number that is found by Equation (3) exist at the interface of plasmon excitation layer 2503 and wave vector conversion layer 2504, the angular distribution of emission light that is found by Equation (6) is also narrowed. Light that is emitted from one point of wave vector conversion layer 2504 has a ring-shaped intensity distribution that spreads concentrically as it propagates. Under the conditions at which Equation (6) is “0,” the intensity is highest in a direction perpendicular to the plane that is orthogonal to the direction of thickness of wave vector conversion layer 2504 in optical element 1, and intensity decreases in correspondence with decrease in the angle that is formed by the direction of light that is emitted from the optical element and the above-described plane of the optical element.

FIG. 26 is a sectional view showing the configuration of another exemplary embodiment of the optical element according to the present invention.

In contrast to the optical elements shown in FIG. 24 and FIG. 25 in which plasmon coupling is carried out with light that is propagated through a light guide body, the optical element of the present exemplary embodiment is an optical element that spontaneously emits light and is provided with light source layer 2611 and directivity control layer 2612 as an optical element layer that is laminated on this light source layer 2611 and into which light from light source layer 2611 is irradiated.

The optical element of the present exemplary embodiment includes: substrate 2601, and a pair of hole transport layer 2603 and electron transport layer 2605 that are provided on this substrate 2601. On substrate 2601, anode 2602, hole transport layer 2603, active layer 2604, and electron transport layer 2605 are each laminated in that order from the side of substrate 2601, and light source layer 2611 is formed by these layers.

Directivity control layer 2612 is provided on the side opposite the substrate 2601-side of the light source layer. Directivity control layer 2612 is provided with plasmon excitation layer 2607 that has a higher plasma frequency than the frequency of light that is emitted from the light source layer, and wave vector conversion layer 2609 as an emission layer that is laminated on this plasmon excitation layer 2607 and that converts the light that is irradiated from plasmon excitation layer 2607 to a predetermined emission angle and emits the light.

In addition, plasmon excitation layer 2607 is sandwiched between two layers having dielectricity. As the two layers having dielectricity, directivity control layer 2612 is provided with high-dielectric constant layer 2608 that is provided sandwiched between plasmon excitation layer 2607 and wave vector conversion layer 2609 and low-dielectric constant layer 2606 that is provided sandwiched between plasmon excitation layer 2607 and electron transport layer 2605 and that has a lower dielectric constant than high-dielectric constant layer 2608.

However, regarding the dielectric constants of high-dielectric constant layer 2608 and low-dielectric constant layer 2606, as will be described hereinbelow, if the real part of the complex effective dielectric constant of the incident-side portion (the substrate 2601-side) of plasmon excitation layer 2607 is set lower than the real part of the complex effective dielectric constant of the emission-side portion (the wave vector conversion layer 2609-side) of plasmon excitation layer 2607, the optical element will operate even though the dielectric constant of low-dielectric constant layer 2606 is higher than the dielectric constant of high-dielectric constant layer 2608. Accordingly, plasmon excitation layer 2607 is arranged sandwiched between the pair of high-dielectric constant layer 2608 and low-dielectric constant layer 2606.

The optical element in the present exemplary embodiment is configured such that the effective dielectric constant of the incident-side portion that includes the entire construction that is laminated on the light source layer-side of plasmon excitation layer 2607 (hereinbelow referred to as simply the “incident-side portion”) is lower than the effective dielectric constant of the emission-side portion that includes the entire construction that is laminated on the wave vector conversion layer 2609-side of plasmon excitation layer 2607 and the medium that is in contact with wave vector conversion layer 2609 (hereinbelow referred to as simply the “emission-side portion”). Substrate 2601 is included with the entire construction that is laminated on the light source layer-side of plasmon excitation layer 2607. Wave vector conversion layer 2609 is included in the entire construction that is laminated on the wave vector conversion layer 2609-side of plasmon excitation layer 2607.

Essentially, in the present exemplary embodiment, the effective dielectric constant of the incident-side portion that includes the light source layer and low-dielectric constant layer 2606 with respect to plasmon excitation layer 2607 is lower than the effective dielectric constant of the emission-side portion that includes high-dielectric constant layer 2608, wave vector conversion layer 2609 and the medium with respect to plasmon excitation layer 2607.

To state in greater detail, the real part of the complex effective dielectric constant of the incident-side portion (the substrate 2601-side) of plasmon excitation layer 2607 is set lower than the real part of the complex effective dielectric constant of the emission-side portion (wave vector conversion layer 2609-side) of plasmon excitation layer 2607.

If the x-axis and y-axis are directions parallel to the interface of plasmon excitation layer 2607, the z-axis is a direction perpendicular to the interface of plasmon excitation layer 2607, ω is the angular frequency of light that is emitted from the light source layer, ∈(ω, x, y, z) is the dielectric constant distribution of the dielectric in the incident-side portion and emission-side portion with respect to plasmon excitation layer 15, k_{spp,z} is the z-component of the wave number of surface plasmons, and j is the imaginary number unit, the complex effective dielectric constant ∈_{eff} is expressed by Equation (1). Here, the integral range D is a three-dimensional coordinate range of the incident-side portion or emission-side portion with respect to plasmon excitation layer 2607. In other words, the ranges of the x-axis and y-axis directions in this integral range D are ranges that do not include the medium as far as the outer peripheral surface of the construction included in the incident-side portion or as far as the outer peripheral surface of the construction that is included in the emission-side portion, and are ranges as far as the outer edge within the plane that is parallel to the interface of plasmon excitation layer 2607. In addition, the range in the z-axis direction in integral range D is the range of the incident-side portion or emission-side portion (including the medium). Regarding the range of the z-axis direction in integral range D, the interface between plasmon excitation layer 2607 and the layer that is contiguous to plasmon excitation layer 2607 and that has dielectricity is taken as the position at which z=0, and the range in the z-axis direction is the range from this interface to an infinite distance on the side of the above-described contiguous layer of plasmon excitation layer 2607, the direction of increasing distance from this interface being the (+) z direction in Equation (1). If an uneven surface is formed on the surface of plasmon excitation layer 2607, the effective dielectric constant is found by using Equation (1) if the origin of the z coordinates is moved along the unevenness of plasmon excitation layer 2607.

In addition, if ∈ₘₑₜₐₗ is the real part of the dielectric constant of plasmon excitation layer 2607 and k₀ is the wave number of light in a vacuum, then the z-component k_{spp,z} of the wave number of surface plasmons and the x- and y-components kₛₚₚ of the wave number of surface plasmons are represented by Equation (2) and Equation (3).

Accordingly, the complex effective dielectric constant ∈_{effin} of the incident-side portion and the complex effective dielectric constant ∈_{effout} of the emission-side portion with respect to plasmon excitation layer 2607 are each found by calculating using Equation (1), Equation (2), and Equation (3) and rolacing each of the dielectric constant distribution ∈ᵢₙ(ω, x, y, z) of the incident-side portion of plasmon excitation layer 2607 and the dielectric constant distribution ∈ₒᵤₜ(ω, x, y, z) of the emission-side portion of plasmon excitation layer 2607, respectively, with ∈(ω, x, y, z). In actuality, the complex effective dielectric constant ∈_{eff} can be easily found by assigning an appropriate initial value as complex effective dielectric constant ∈_{eff} and then repeatedly calculating Equation (1), Equation (2), and Equation (3). When the dielectric constant of the layer that is in contact with plasmon excitation layer 2607 is extremely high, the z-component K_{spp,z} of the wave number of surface plasmons at this interface becomes a real number. This case corresponds to a case in which surface plasmons are not generated at the interface. As a result, the dielectric constant of the layer that is in contact with plasmon excitation layer 2607 corresponds to the effective dielectric constant in this case. If the effective interactive distance of surface plasmons is here assumed to be the distance at which the intensity of surface plasmons is e⁻², the effective interactive distance d_{eff} of surface plasmons is represented by Equation (4).

Low-dielectric constant layer 2606 that belongs to the directivity control layer is a layer in which the dielectric constant is lower than that of high-dielectric constant layer 2608. The complex dielectric constant of low-dielectric constant layer 2606 is ∈ₗ(λ₀), the real part of this value being ∈ₗᵣ(λ₀) and the imaginary part being ∈ₗᵢ(λ₀). If the complex dielectric constant of high-dielectric constant layer 2608 is ∈ₕ(λ₀), the real part of this value is ∈ₕᵣ(λ₀) and the imaginary part is ∈ₕᵢ(λ₀), then the relation 1≦∈ₗᵣ(λ₀)<∈ₕᵣ(λ₀) is satisfied. The value λ₀ is the wavelength in a vacuum of the light that is incident to the dielectric constant layer.

However, even when the dielectric constant of low-dielectric constant layer 2606 is higher than the dielectric constant of high-dielectric constant layer 2608, the optical element will operate if the real part of the effective dielectric constant of the low-dielectric constant layer 2606-side of plasmon excitation layer 2607 is lower than the real part of the effective dielectric constant of the high-dielectric constant layer 2608-side of plasmon excitation layer 2607. Essentially, the dielectric constants of low-dielectric constant layer 2606 and high-dielectric constant layer 2608 have a permissible range in which the real part of the effective dielectric constant of the emission-side portion of plasmon excitation layer 2607 is kept higher than the real part of the effective dielectric constant of the incident-side portion.

In addition, imaginary part ∈ₗᵢ(λ₀) and imaginary part ∈ₕᵢ(λ₀) in the emission frequency is preferably as low as possible, whereby plasmon coupling can be facilitated and light loss can be reduced.

In any layer that includes the light source layer and in the medium that is in contact with wave vector conversion layer 2609, the imaginary part of the complex dielectric constant in the emission frequency is preferably made as low as possible. Making the imaginary part of the complex dielectric constant as low as possible facilitates the occurrence of plasmon coupling and enables a reduction of light loss.

In addition, a portion on each layer that is above hole transport layer 2603 is cut out to expose a portion of the surface that is orthogonal to the direction of thickness of hole transport layer 2603 of the optical element, and anode 2602 is provided on the portion of hole transport layer 2603 that is thus exposed. Similarly, the optical element is configured such that a portion of each of high-dielectric constant layer 2608 and wave vector conversion layer 2609 that are above plasmon excitation layer 2607 is cut away to expose, to the outside, a portion of the surface that is orthogonal to the direction of thickness of plasmon excitation layer 2607, and the portion of plasmon excitation layer 2607 that is exposed functions as a cathode. Accordingly, in the configuration of the optical element of the present exemplary embodiment, electrons are injected from plasmon excitation layer 2607 and holes (positive holes) are injected from anode 2602. The relative positions of electron transport layer 2605 and hole transport layer 2603 in the light source layer may be arranged opposite to the positions of each in the present exemplary embodiment. In addition, a cathode pad of a material that differs from that of plasmon excitation layer 2607 may be provided on plasmon excitation layer 2607 in which the surface was exposed.

The medium in the vicinity of the optical element may be any of a solid, a liquid, or gas, and the mediums on the substrate 2601-side and the wave vector conversion layer 2609-side of the optical element may differ from each other.

Examples that can be offered as hole transport layer 2603 include an aromatic amine compound or tetraphenyl diamine. Alternatively, a p-type semiconductor layer that constitutes a typical LED or semiconductor laser may also be used as hole transport layer 2603.

Examples of materials that can be used as electron transport layer 2605 include Alq3, oxadiazole (PBD) and triazole (TAZ). Alternatively, an n-type semiconductor layer that constitutes a semiconductor laser or a typical LED may also be used as electron transport layer 2605.

In addition, a configuration is also possible in which other layers such as a buffer layer and even an additional hole transport layer or electron transport layer are inserted between each of the layers that make up the light source layer, and a known LED structure can also be applied as the light source layer.

In addition, the light source layer may be provided with a reflection layer (not shown) between hole transport layer 2603 and substrate 2601 that reflects light from active layer 2604. In the case of this configuration, examples that can be suggested as the reflection layer include a metal film of, for example, Ag or Al, or a dielectric multilayer film.

Materials that can be suggested as preferable for use as low-dielectric constant layer 2606 include: SiO₂ nano-rod array film or a thin film or porous film of SiO₂, AlF₃, MgF₂, Na₃AlF₆, NaF, LiF, CaF₂, BaF₂, and a low dielectric constant plastic. In addition, materials that can be suggested as preferable for use as low-dielectric constant layer 14 include materials that are made conductive by doping ions, donors, acceptors, and porous film that takes a conductive material as its principal constituent material such as ITO, MG(OH)₂:C, SnO₂, Cl2A7, TiO₂:Nb, ZnO:Al₂O₃, ZnO:Ga₂O₃ is particularly preferable. The optimum value for the thickness of low-dielectric constant layer 2606 is in the range of 5 nm to 50 nm.

As high-dielectric constant layer 2608, a thin film or porous film of a material having a high dielectric constant is preferably used, for example, diamond, TiO₂, CeO₂, Ta₂O₅, ZrO₂, Sb₂O₃, HfO₂, La₂O₃, NdO₃, Y₂O₃, ZnO, Nb₂O₅.

Plasmon excitation layer 2607 is realized by the metal-dielectric composite shown in FIG. 7 or by a multilayer film composed of metal and a dielectric shown in FIG. 19, and is a particulate layer or a thin-film layer formed of a material having a plasma frequency higher than the frequency of light (emission frequency) that is produced by the light source layer. In other words, plasmon excitation layer 2607 has a negative dielectric constant in the emission frequency that is produced by the light source layer.

Materials that can be suggested as the metal material of plasmon excitation layer 2607 include gold, silver, copper, platinum, palladium, rhodium, osmium, ruthenium, iridium, iron, tin, zinc, cobalt, nickel, chromium, titanium, tantalum, tungsten, indium, aluminum, or an alloy of these metals. Of these, gold, silver, copper, platinum, aluminum, or an alloy that takes these as principal ingredients is preferable as the material of plasmon excitation layer 2607, and gold, silver, platinum, aluminum, or an alloy that takes these as a principal ingredient are particularly preferable. The material that is used as the dielectric material of plasmon excitation layer 2607 is preferably a material having a dielectric constant that is as low as possible, and the use of low-dielectric constant materials such as air, SiO₂, AlF₃, MgF₂, Na₃AlF₆, NaF, LiF, CaF₂, BaF₂, and low-dielectric constant plastic is preferable.

The thickness of plasmon excitation layer 2607 is preferably formed at no more than 200 nm, and is particularly preferably formed on the order of from 10 nm to 100 nm.

Wave vector conversion layer 2609 is an emission layer for extracting light from high-dielectric constant layer 2608 by converting the wave vector of incident light that is irradiated into this wave vector conversion layer 2609 and emitting light from the optical element. In other words, wave vector conversion layer 2609 converts the emission angle of light from high-dielectric constant layer 2608 to a predetermined angle and emits the light from the optical element. Essentially, wave vector conversion layer 2609 performs the function of emitting radiation 2610 from the optical element such that radiation 2610 is substantially orthogonal to the interface with high-dielectric constant layer 2608.

Examples of materials that are used as wave vector conversion layer 2609 include a periodic structure of which a surface relief grating or a photonic crystal is representative, a quasi-periodic structure (a textured structure having unevenness that is larger than the wavelength of light from high-dielectric constant layer 2608) or a quasi-crystal structure, a surface structure in which a rough surface is formed, a hologram, and a micro-lens array. A quasi-periodic structure refers to, for example, an incomplete periodic structure in which a portion of the periodic structure is missing. Of these materials, a periodic structure as represented by a photonic crystal, a quasi-periodic structure, a quasi-crystal structure, or a micro-lens array is preferably used. These materials are preferred because they not only raise the extraction efficiency of light but also enable control of directivity. When photonic crystal is used, the crystalline structure preferably has a triangular lattice construction. In addition, wave vector conversion layer 2609 may be of a construction in which protrusions are provided on a plate-shaped base part. Alternatively, wave vector conversion layer 2609 may be configured from a different material than high-dielectric constant layer 2608.

The operation of emitting light from wave vector conversion layer 2609 is next described for the optical element that is configured as described hereinabove.

Electrons are injected from a portion of plasmon excitation layer 2607 that serves as a cathode, and holes are injected from anode 2602. The electrons and holes that have been injected into light source layer 2611 from the portion of plasmon excitation layer 2607 and anode 2602 pass by way of electron transport layer 2605 and hole transport layer 2603, respectively, and are injected between electron transport layer 2605 and hole transport layer 2603. The electrons and holes that have been injected between electron transport layer 2605 and hole transport layer 2603 couple with electrons or holes in plasmon excitation layer 2607 and light is emitted to the high-dielectric constant layer 2608 side.

An inorganic material (semiconductor) such as InGaN, AlGaAs, AlGaInP, GaN, ZnO, or diamond or an organic material (semiconductor material) such as (thiophene/phenylene) co-oligomer or Alq3 is used as active layer 2604. In addition, active layer 2604 preferably adopts a quantum well construction.

The distance from the interface of high-dielectric constant layer 2608 and plasmon excitation layer 2607 to the interface of electron transport layer 2605 and active layer 2604 is preferably formed at no more than 500 nm, this distance preferably being as short as possible. This distance corresponds to the distance at which plasmon coupling occurs between active layer 2604 and plasmon excitation layer 2607.

In the optical element of the present exemplary embodiment, electrons and holes that have been injected from a portion of plasmon excitation layer 2607 and anode 2602 into the light source layer pass by way of electron transport layer 2605 and hole transport layer 2603, respectively, and are injected into active layer 2604. Electrons and holes that are injected into active layer 2604 couple with electrons or holes in plasmon excitation layer 2607 and light is emitted toward the high-dielectric constant layer 2608 side. In this way, light that is irradiated into high-dielectric constant layer 2608 is emitted from wave vector conversion layer 2609.

Because only wave numbers in the vicinity of the wave number found by Equation (3) exist at the interface of plasmon excitation layer 2607 and high-dielectric constant layer 2608, the angular distribution of light that is emitted from high-dielectric constant layer 2608 that is found by Equation (5) is also narrowed. The light that is emitted from a point of high-dielectric constant layer 2608 has a ring-shaped intensity distribution that spreads concentrically as it propagates.

Because the optical element of the present exemplary embodiment as described hereinabove uses a material that is the same as that of a typical LED for the material that makes up the light source layer, the optical element is able to realize a high luminance similar to an LED. In addition, according to the optical element of the present exemplary embodiment, the angle of incidence of light that is irradiated into wave vector conversion layer 17 is determined by the effective dielectric constant of plasmon excitation layer 2607 and the incident-side portion of plasmon excitation layer 2607, the effective dielectric constant of the emission-side portion, and the spectral width of the emission that is produced by electrons and holes that have been injected into active layer 2604, and as a result, the constraint of the directivity of the light source layer upon on the directivity of emission light from the optical element is eliminated. The optical element of the present exemplary embodiment, through the application of plasmon coupling in the process of radiation, enables a narrowing of the radiation angle of light that is emitted from the optical element to increase the directivity of emitted light.

FIG. 27 is a sectional view showing the configuration of another exemplary embodiment of the optical element according to the present invention.

In contrast to the optical element shown in FIG. 24 and FIG. 25, which is an element in which plasmon coupling takes place with light that has been propagated through a light guide body, the optical element of the present exemplary embodiment is an optical element that spontaneously produces light and is provided with light source layer 2709 and directivity control layer 2710 that is laminated on this light source layer 2709 as the optical element layer into which light from light source layer 2709 is irradiated.

Light source layer 2709 includes substrate 2701, the pair of hole transport layer 2703 and electron transport layer 2705 that are provided on this substrate 2701, and active layer 2704. Hole transport layer 2703, active layer 2704, and electron transport layer 2705 are each laminated on substrate 2701 in that order from the substrate 2701-side.

Directivity control layer 2710 is provided on the side of light source layer 2709 that is opposite the side of substrate 2701. Directivity control layer 2710 includes plasmon excitation layer 2706 that has a plasma frequency higher than the frequency of light that is emitted from light source layer 2709, and wave vector conversion layer 2707 as the emission layer that is laminated on this plasmon excitation layer 2706 and that converts light that is irradiated from plasmon excitation layer 2706 to a predetermined emission angle and emits light.

In addition, a portion of each layer above hole transport layer 2703 is cut away so as to expose a portion of the surface that is orthogonal to the direction of thickness of hole transport layer 2703, and the optical element is provided with anode 2702 on the portion of hole transport layer 2703 that is exposed. Similarly, in the optical element, a portion of wave vector conversion layer 2707 above plasmon excitation layer 2706 is cut away so as to expose to the outside a portion of the surface that is orthogonal to the direction of thickness of plasmon excitation layer 2706, and the portion of plasmon excitation layer 2706 that is exposed functions as a cathode. Accordingly, in the configuration of optical element 2709 of the present exemplary embodiment, electrons are injected from plasmon excitation layer 2706, and holes (positive holes) are injected from anode 2702.

The relative positions of electron transport layer 2705 and hole transport layer 2703 in the light source layer may be arranged opposite the positions of each in the present exemplary embodiment. A cathode that is formed from a material that differs from that of plasmon excitation layer 2706 may be provided on all or a portion on plasmon excitation layer 2706 in which the surface is exposed. A cathode and anode that constitute an LED and organic EL may be used as the cathode and anode. When the cathode is formed over the entire surface that is exposed on plasmon excitation layer 2706, the cathode is preferably transparent at the frequency of light that is emitted from the light source layer.

The medium that surrounds the optical element may be any of a solid, liquid, or gas, and the medium on the substrate 2701-side and wave vector conversion layer 2707-side of the optical element may differ from each other.

A p-type semiconductor that constitutes a typical LED or semiconductor laser, or an aromatic amine compound or tetraphenyl diamine that is a hole transport layer for an organic EL may be used for hole transport layer 2703.

An n-type semiconductor that constitutes a semiconductor laser or a typical LED, a triazole (TAZ), oxadiazole (PBD), or Alq3 that is an electron transport layer for organic EL may be used for electron transport layer 2705.

In addition, a configuration may be adopted in which other layers such as buffer layers or still other hole transport layers or electron transport layers are inserted between each of the layers that make up the light source layer, and a known LED or organic EL structure can be applied.

The light source layer may be further provided with a reflection layer (not shown) between hole transport layer 2703 and substrate 2701 that reflects light from active layer 2704. In the case of this configuration, a metal film of, for example, Ag or Al and a dielectric multilayer film may be used as the reflection layer.

Plasmon excitation layer 2706 is sandwiched between two layers having dielectricity. In the present exemplary embodiment, these two layers correspond to electron transport layer 2705 and wave vector conversion layer 2707. The optical element in the present exemplary embodiment is configured such that the effective dielectric constant of the incident-side portion that includes all construction that is laminated on the light source layer-side of plasmon excitation layer 2706 (hereinbelow referred to as the “incident-side portion”) is higher than the effective dielectric constant of the emission-side portion that includes the entire construction that is laminated on the wave vector conversion layer 2707-side of plasmon excitation layer 2706 and the medium that contacts wave vector conversion layer 2707 (hereinbelow referred to as the “emission-side portion”). Wave vector conversion layer 2707 is included in the entire construction that is laminated on the wave vector conversion layer 2707-side of plasmon excitation layer 2706.

Essentially, in the present exemplary embodiment, the effective dielectric constant of the incident-side portion that includes the entire light source layer with respect to plasmon excitation layer 2706 is higher than the effective dielectric constant of the emission-side portion that includes wave vector conversion layer 2707 and the medium with respect to plasmon excitation layer 2706.

To state in greater detail, the real part of the complex effective dielectric constant of the incident-side portion (light source layer side) of plasmon excitation layer 2706 is set higher than the real part of the complex effective dielectric constant of the emission-side portion (the wave vector conversion layer 2707-side) of plasmon excitation layer 2706.

Here, if the x-axis and y-axis are directions parallel to the interface of plasmon excitation layer 2706, the z-axis is a direction perpendicular to the interface of plasmon excitation layer 2706, w is the angular frequency of light that is emitted from the light source layer, ∈(ω, x, y, z) is the dielectric constant distribution of the dielectric in the incident-side portion or emission-side portion with respect to plasmon excitation layer 15, k_{spp,z} is the wave number of surface plasmons, and j is the imaginary number units, then complex effective dielectric constant ∈_{eff} is represented by Equation (1). Here, the integral range D is the range of three-dimensional coordinates of the incident-side portion or emission-side portion with respect to plasmon excitation layer 15. In other words, the range in the x-axis and y-axis directions in this integral range D is a range that does not include the medium as far as the outer peripheral surface of the construction that is included in the incident-side portion or as far as the outer peripheral surface of the construction that is included by the emission-side portion and is a range as far as the outer edge in the plane that is parallel to the interface of plasmon excitation layer 2706. In addition, the range in the z-axis direction in integral range D is the range of the incident-side portion or emission-side portion (including the medium). Regarding the range in the z-axis direction in integral range D, taking the interface of plasmon excitation layer 2706 and the layer having dielectricity that is adjacent to plasmon excitation layer 2706 as the position at which z=0, the range in the z-axis direction is the range from this interface to an infinite distance on the side of the above-described adjacent layer of plasmon excitation layer 2706, the direction of increasing distance from this interface being the (+) z direction in Equation (1). If unevenness is formed on the surface of plasmon excitation layer 2706, the effective dielectric constant is found using Equation (1) if the origin of the z coordinates is moved along the unevenness of plasmon excitation layer 2706.

In addition, if ∈ₘₑₜₐₗ is the real part of the dielectric constant of plasmon excitation layer 2706 and k₀ is the wave number of light in a vacuum, the z-component k_{spp,z} of the wave number of surface plasmons and the x- and y-component kₛₚₚ of the wave number of surface plasmons are represented by Equation (2) and Equation (3).

Accordingly, the complex effective dielectric constant ∈_{effin} of the incident-side portion and the complex effective dielectric constant ∈_{effout} of the emission-side portion with respect to plasmon excitation layer 2706 are each found by calculating using Equation (1), Equation (2), and Equation (3) and replacing each of the dielectric constant distribution ∈ₘ(ω, x, y, z) of the incident-side portion of plasmon excitation layer 2706 and the dielectric constant distribution ∈ₒᵤₜ(ω, x, y, z) of the emission-side portion of plasmon excitation layer 2706, respectively, with ∈(ω, x, y, z). In actuality, the complex effective dielectric constant ∈_{eff} can be easily found by assigning an appropriate initial value as complex effective dielectric constant ∈_{eff} and then repeatedly calculating Equation (1), Equation (2), and Equation (3). When the real part of the dielectric constant of the layer that is in contact with plasmon excitation layer 2607 is extremely high, the z-component K_{spp,z} of the wave number of surface plasmons at this interface becomes a real number. This case corresponds to a case in which surface plasmons are not generated at the interface. As a result, the dielectric constant of the layer that contacts plasmon excitation layer 2607 corresponds to the effective dielectric constant in this case.

If the effective interactive distance of surface plasmons is here assumed to be the distance at which the intensity of surface plasmons is e⁻², the effective interactive distance d_{eff} of surface plasmons is expressed by Equation (4).

In any layer that includes the light source layer and in the medium that is in contact with wave vector conversion layer 2707, the imaginary part of the complex dielectric constant in the emission frequency is preferably as low as possible. Making the imaginary part of the complex dielectric constant as low as possible facilitates the occurrence of plasmon coupling and can reduce light loss.

Plasmon excitation layer 2706 is a component according to the metal-dielectric composite shown in FIG. 7 or a component according to the multilayer film composed of metal and dielectric that is shown in FIG. 19, and is a particulate layer or thin-film layer formed by a material having a plasma frequency that is higher than the frequency (emission frequency) of light that is generated by the light source layer. In other words, plasmon excitation layer 2706 has a negative dielectric constant at the emission frequency that is produced by the light source layer.

Materials that can be suggested as the metal material of plasmon excitation layer 2706 include gold, silver, copper, platinum, palladium, rhodium, osmium, ruthenium, iridium, iron, tin, zinc, cobalt, nickel, chromium, titanium, tantalum, tungsten, indium, aluminum, or an alloy of these metals. Of these, gold, silver, copper, platinum, aluminum, and an alloy that takes these as principal ingredients are preferable as the material of plasmon excitation layer 2706, and gold, silver, platinum, aluminum, and an alloy that takes these as principal ingredients are particularly preferable. The material that is used as the dielectric material of plasmon excitation layer 2706 is preferably a material having a dielectric constant that is as low as possible, the use of low-dielectric constant materials such as air, SiO₂, AlF₃, MgF₂, Na₃AlF₆, NaF, LiF, CaF₂, BaF₂, and low-dielectric constant plastic being preferable.

The thickness of plasmon excitation layer 2706 is preferably formed at no more than 200 nm, and is particularly preferably formed in the order of from 10 nm to 100 nm.

Wave vector conversion layer 2707 is an emission layer for extracting light from the interface of plasmon excitation layer 2706 and wave vector conversion layer 2707 by converting the wave vector of surface plasmons that are excited at the interface of plasmon excitation layer 2706 and wave vector conversion layer 2707 and emitting light from the optical element. In other words, wave vector conversion layer 2707 converts surface plasmons to light of a predetermined emission angle and emits light from the optical element. Essentially, wave vector conversion layer 2707 performs the function of emitting radiation 2708 from the optical element such that radiation 2708 is substantially orthogonal to the interface of plasmon excitation layer 2706 and wave vector conversion layer 2707.

Examples of materials that are used as wave vector conversion layer 2707 include a periodic structure of which a surface relief grating or a photonic crystal is representative, a quasi-periodic or a quasi-crystal structure, a textured structure that is larger than the wavelength of light from the light source layer, a surface structure in which a rough surface is formed, a hologram, and a micro-lens array. A quasi-periodic structure refers to, for example, an incomplete periodic structure in which a portion of the periodic structure is missing. Of these materials, a periodic structure as represented by a photonic crystal, a quasi-periodic structure, a quasi-crystal structure, or a micro-lens array is preferably used. These materials are preferred because they not only raise the extraction efficiency of light but because they also enable the control of directivity. When photonic crystal is used, the crystalline structure preferably has a triangular lattice construction. In addition, wave vector conversion layer 2706 may be of a construction in which protrusions or depressions that form a periodic structure are provided on a plate-shaped base part.

A material that is the same as material used in an LED or organic EL can be used as active layer 2704 that belongs to the light source layer, and for example, an inorganic material (semiconductor) such as InGaN, AlGaAs, AlGaInP, GaN, ZnO, and diamond, or an organic material (semiconductor material) such as (thiophene/phenylene) co-oligomer and Alq3 is used. Active layer 12 preferably adopts a quantum-well structure. In addition, the emission spectrum of active layer 2704 is preferably as narrow as possible.

The distance from the interface of wave vector conversion layer 2707 and plasmon excitation layer 2706 to the interface of electron transport layer 2705 and active layer 2704 should be as short as possible. The greatest permissible value of this distance corresponds to the distance at which plasmon coupling occurs between active layer 2704 and plasmon excitation layer 2706 and is calculated by Equation (4).

The operation of emitting light from wave vector conversion layer 2707 in the optical element that is configured as described above is next described.

Electrons and holes that have been injected into the light source layer from a portion of plasmon excitation layer 2706 and anode 2702 pass by way of electron transport layer 2705 and hole transport layer 2703, respectively, and are injected into active layer 2704. The electrons and holes that have been injected into active layer 2704 couple with electrons or holes in plasmon excitation layer 2706, and surface plasmons in the interface of plasmon excitation layer 2706 and wave vector conversion layer 2707 are excited. The excited surface plasmons are diffracted at wave vector conversion layer 2707 and emitted from wave vector conversion layer 2707.

When the dielectric constant of the interface of plasmon excitation layer 2706 and wave vector conversion layer 2707 is spatially uniform, i.e., when the interface is a flat surface, these surface plasmons cannot be extracted. As a result, the provision of wave vector conversion layer 2707 enables diffraction of the surface plasmons and extraction as light. When the angle of emission that has the highest intensity is the central angle of emission, the central emission angle θ_{rad} of light that is emitted from wave vector conversion layer 2707 is expressed by Equation (6), where Λ is the pitch of the periodic structure of wave vector conversion layer 2707. Here, “i” is a natural number. With the exception of the condition in which Equation (6) is “0,” the light that is emitted from a point on wave vector conversion layer 2707 has a ring-shaped intensity distribution that spreads concentrically as the light is propagated. Under the conditions at which Equation (6) is “0,” the intensity is highest in the direction that is perpendicular to the plane that is orthogonal to the direction of thickness of wave vector conversion layer 2707 in optical element 1, and the intensity decreases corresponding to decreases in the angle formed by the emission direction of light from the optical element and the above-described plane of the optical element. In the interface of plasmon excitation layer 15 and wave vector conversion layer 17, only wave numbers in the vicinity of the wave number that is found by Equation (3) exist, and the angular distribution of emitted light found by Equation (6) therefore also narrows.

In the optical element of the present exemplary embodiment as described hereinabove, the same material as in a typical LED is used in the material that makes up the light source layer, whereby high luminance similar to an LED can be realized. In addition, in the optical element of the present exemplary embodiment, the emission angle of light that is emitted from wave vector conversion layer 2707 is determined by the complex dielectric constant of plasmon excitation layer 2706, the effective dielectric constant of the incident-side portion and the effective dielectric constant of the emission-side portion that sandwich plasmon excitation layer 2706, and the emission spectrum of light that is generated in the optical element. As a result, the constraint of the directivity of the light source layer upon the directivity of the light that is emitted from the optical element is eliminated. In addition, due to the application of plasmon coupling in the process of radiation, the optical element of the present exemplary embodiment can narrow the radiation angle of light emitted from the optical element and thus raise the directivity of emission light.

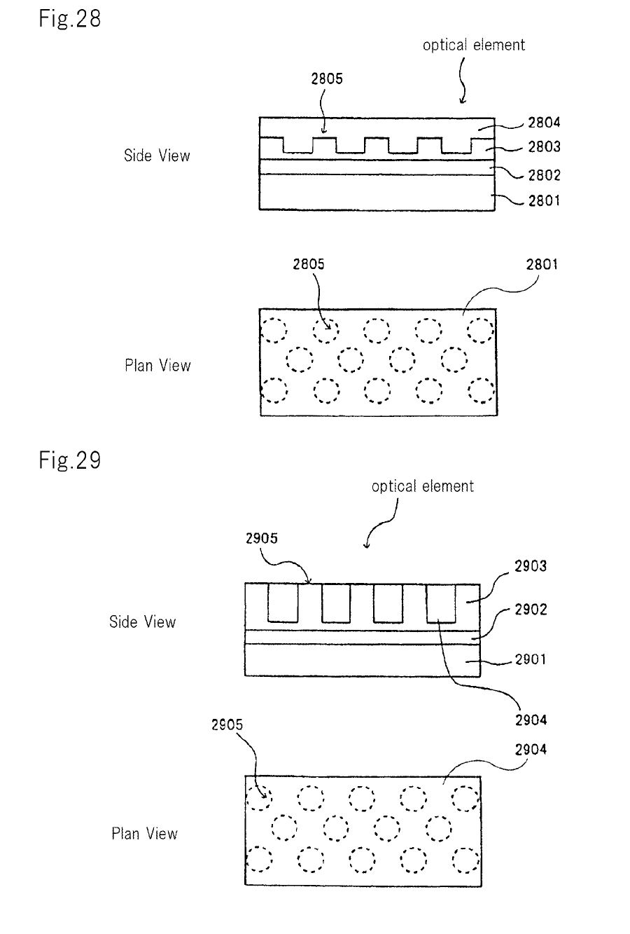

FIG. 28 is a sectional view showing the configuration of another exemplary embodiment of the optical element according to the present invention.

As shown in the figure, in the optical element according to the present exemplary embodiment, substrate 2801, plasmon excitation layer 2802, high-dielectric constant layer 2803, and fluorescent material layer 2804 are laminated in that order. Fluorescent material layer 2804 covers high-dielectric constant layer 2803. In addition, the surface of fluorescent material layer 2804 that is opposite the surface that is in contact with high-dielectric constant layer 2803 is flat.

The material of substrate 2801 can be, for example, glass.

Plasmon excitation layer 2802 is a layer realized by the metal-dielectric composite shown in FIG. 7 or a layer according to the multilayer film composed of a metal and a dielectric shown in FIG. 19, and is a plasmon excitation layer that excites surface plasmons. As the metal material, the plasmon excitation layer is formed of metals such as gold, silver, copper, platinum, palladium, rhodium, osmium, ruthenium, iridium, iron, tin, zinc, cobalt, nickel, chromium, titanium, tantalum, tungsten, indium, aluminum, or an alloy of these metals. In addition, the thickness of metal layer 12 is preferably formed at no greater than 200 nm and is particularly preferably formed in the range of from 10 nm to 100 nm. As the dielectric material of plasmon excitation layer 2802, a material having a dielectric constant as low as possible is preferable, and the use of low-dielectric constant materials such as air, SiO₂, AlF₃, MgF₂, Na₃AlF₆, NaF, LiF, CaF₂, BaF₂ and low-dielectric constant plastic is preferable.

High-dielectric constant layer 2803 is a dielectric layer formed of a dielectric having a dielectric constant higher than 2.25. The dielectric constant of high-dielectric constant layer 2803 is preferably as high as possible.

In high-dielectric constant layer 2803, the surface that is in contact with fluorescent layer 2804 has grating structure 2805 that functions as a diffraction grating. Examples that can be offered as grating structure 2805 include an uneven structure, a photonic crystal, and a lens array. An uneven structure includes a moth-eye structure in which protrusions are in a conical shape. In the present exemplary embodiment, grating structure 2805 is assumed to be an uneven structure. The unevenness of the uneven structure is preferably arranged in a triangular lattice form but may also be arranged in a one-dimensional lattice form.

Fluorescent material layer 2804 is a carrier generation layer that absorbs incident light that has been irradiated, generates excitons (carriers), and then brings about the emission of fluorescent light by means of the excitons. As the material of fluorescent material layer 2804, a nano-inorganic fluorescent such as a quantum dot fluorescent material is preferable, but an organic fluorescent material or inorganic fluorescent material such as Eu, BaMgAlxOy:Eu and BaMgAlxOy:Mn is also possible.

In the optical element that is configured as described hereinabove, upon irradiation of light into fluorescent material layer 2804, the irradiated incident light excites excitons in fluorescent material layer 2804. A portion of the excitons relax and are thus converted to fluorescent light and emitted from the optical element. A portion of the remaining excitons excite surface plasmons in the interface of plasmon excitation layer 2802 and high-dielectric constant layer 2803. The excited surface plasmons are diffracted by grating structure 2805 and emitted from the optical element.

In order that the above-described surface plasmons are excited, wave number kₛₚₚ of the X- and Y-components of the wave number of the surface plasmons must match period K_{g} of the diffraction grating. In other words, if m is a positive integer, the relation kₛₚₚ=m·K_{g} must be satisfied.

Wave number kₛₚₚ is determined according to the dielectric constant distribution of the input/output portion of the optical element. The input/output portion is the medium that exists more to the high-dielectric constant layer 2803-side of plasmon excitation layer 2802 (in FIG. 28, high-dielectric constant layer 2803 and fluorescent material layer 2804).

If ∈ₘₑₜₐₗ is the real part of the dielectric constant of plasmon excitation layer 2802 and k₀ is the wave number of light in a vacuum, wave number kₛₚₚ of the X-component and Y-component of the wave number of surface plasmons and the Z-component k_{spp,z} of the wave number of surface plasmons are expressed by Equation (2) and Equation (3). ∈_{eff} is the complex effective dielectric constant of the input/output portion. If ω is the angular frequency of fluorescent light that is emitted from fluorescent material layer 2804, ∈(ω, x, y, z) is the dielectric constant distribution of the input/output portion, and j is the imaginary number units, then the complex effective dielectric constant ∈_{eff} is expressed by Equation (1).

The integral range D in Equation (1) is the three-dimensional range on the high-dielectric constant layer 2803-side of plasmon excitation layer 2802. More specifically, the range of the XY-plane of integral range D is the range within plasmon excitation layer 2802, and the range of the z-direction of the integral range is the range from the interface of plasmon excitation layer 2802 and high-dielectric constant layer 2803 to an infinite distance on the side of high-dielectric constant layer 2803. In addition, taking the interface of plasmon excitation layer 2802 and high-dielectric constant layer 2803 as Z=0, the +Z-direction is the direction of increasing distance from this interface and toward the high-dielectric constant layer 2803-side.

Wave number kₛₚₚ can be found from the dielectric constant distribution ∈(ω, x, y, z) of the input/output portion by using Equation (1), Equation (2), and Equation (3). More specifically, the actual complex effective dielectric constant ∈_{eff} is calculated by inserting the dielectric constant distribution ∈(ω, x, y, z) of the input/output portion into Equation (1), assigning an appropriate initial value to complex effective dielectric constant ∈_{eff}, and using Equation (1), Equation (2), and Equation (3) to repeatedly calculate wave number kₛₚₚ and k_{spp,z} of surface plasmons and complex effective dielectric constant ∈_{eff}, and wave number kₛₚₚ can be found from the actual complex effective dielectric constant ∈_{eff}.

Accordingly, if Equation (1), Equation (2), and Equation (3) are used to adjust the period of the diffraction grating and the dielectric constant distribution of the input/output portion such that kₛₚₚ=m·K_{g}, excited surface plasmons can be efficiently extracted and the effect of intensifying fluorescent light can be increased.

FIG. 29 is a sectional view showing the configuration of another exemplary embodiment of the optical element according to the present invention.

In the present exemplary embodiment, each of substrate 2901, plasmon excitation layer 2902, high-dielectric constant layer 2903, fluorescent material layer 2904, and grating structure 2905 is the same as substrate 2801, plasmon excitation layer 2802, high-dielectric constant layer 2803, fluorescent material layer 2804, and grating structure 2805, respectively, shown in FIG. 28.

In contrast to the optical element shown in FIG. 28 in which fluorescent material layer 2804 covers high-dielectric constant layer 2803 and the surface of fluorescent material layer 2804 that is opposite the surface that is in contact with high-dielectric constant layer 2803 is flat, in the present exemplary embodiment, fluorescent material layer 2904 is embedded in the depression of high-dielectric constant layer 2903, and the height of fluorescent material layer 2904 and the height of the protrusion of high-dielectric constant layer 2903 are the same.

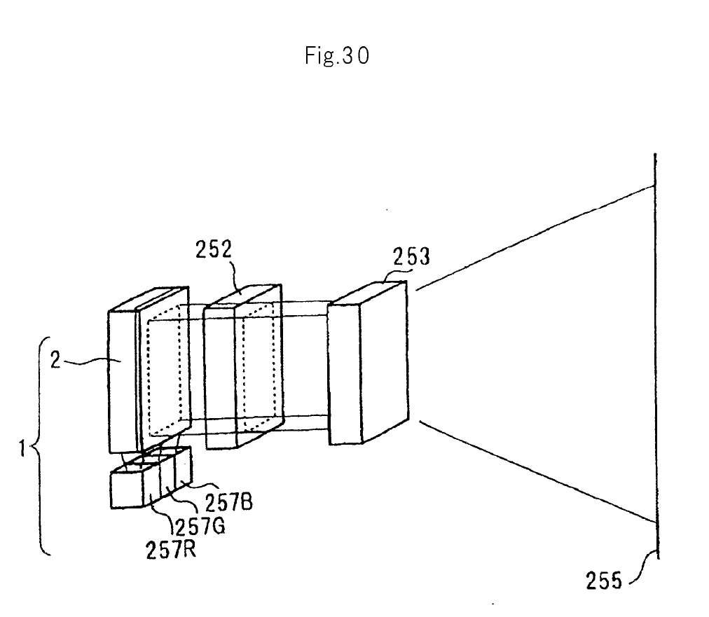

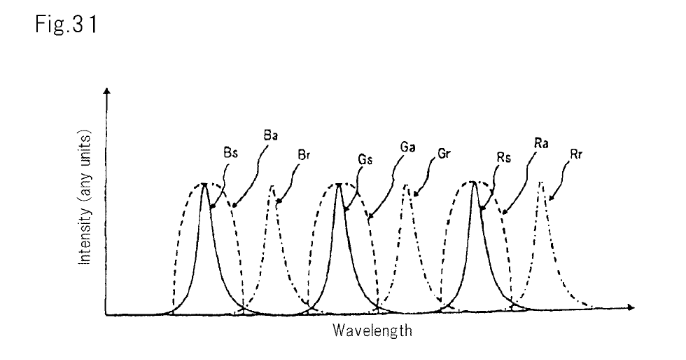

Finally, an LED projector is briefly described as a projection-type display device in which the light source device of the above-described exemplary embodiment is applied. FIG. 30 shows a schematic view of the projection-type display device of the exemplary embodiment.

As shown in FIG. 30, the LED projector of the exemplary embodiment is provided with: light source 1 that uses the optical element of the above-described exemplary embodiment, liquid crystal panel 252 into which emission light from light source 1 is irradiated, and projection optical system 253 that includes projection lenses that project the emitted light from this liquid crystal panel 252 onto projection surface 255 such as a screen.

In light source device 1 that is provided in the LED projector, each of red (R) light LED 257R, green (G) light LED 257G, and blue (B) light LED 257B that are provided with the configuration of the optical element shown in FIG. 26 or FIG. 28 is arranged on one side surface of light guide body 2 provided in the configuration of the optical element shown in FIG. 25 or FIG. 26. The carrier generation layer that belongs to the directivity control layer of light source device 2 includes fluorescent material for red (R) light, green (G) light, and blue (B) light.

FIG. 31 shows the relation of the wavelength of light source 1 that is used in the LED projector of the exemplary embodiment and excitation wavelength and intensity of the emission wavelength of the fluorescent material. As shown in FIG. 31, the emission wavelengths Rs, Gs, and Bs of R-light LED 257R, G-light LED 257G, and B-light LED 257B, and the excitation wavelengths Ra, Ga, and Ba, respectively, of the fluorescent material are set substantially equal. In addition, these emission wavelengths Rs, Gs, and Bs, and excitation wavelengths Ra, Ga, and Ba, and fluorescent material emission wavelengths Rr, Gr, and Gr are set so as not to overlap each other. In addition, the emission spectrums of R-light LED 257R, G-light LED 257G, and B-light LED 257B are set to either match the excitation spectrums of the respective fluorescent material or to be accommodated within the excitation spectrums. The emission spectrums of the fluorescent materials are further set so that they almost never overlap with any of the excitation spectrums of the fluorescent materials.

A time division method is adopted in the LED projector, and switching is implemented by a control circuit unit (not shown) such that light is emitted from only one LED from among R-light LED 257R, G-light LED 257G, and B-light LED 257B.

According to the LED projector of the present exemplary embodiment, the provision of light source device 2 of the above-described exemplary embodiment enables improving the luminance of the projected image.

Although an example of the configuration of a single-panel liquid crystal projector was shown as the LED projector of the exemplary embodiment, the present invention may, of course, also be applied to a three-panel liquid crystal projector provided with a liquid crystal panel for each of R, G, and B.

Although each exemplary embodiment has been described by way of examples provided with a light guide body, the light guide body is not an indispensible constituent element, and in place of a light guide body, the light-emitting surface of a light-emitting element may be arranged in proximity to a carrier generation layer. Still further, a configuration may be adopted in which a light-emitting element is arranged separated by a space and light from the light-emitting element is irradiated upon the carrier generation layer. The light-emitting element is not an indispensible constituent element.

Although the present invention has been described hereinabove with reference to exemplary embodiments, the present invention is not limited to the above-described exemplary embodiments. The configuration and details of the present invention are open to various modifications within the scope of the present invention that will be clear to one of ordinary skill in the art.

Although the present invention has been described hereinabove with reference to exemplary embodiments, the present invention is not limited to the above-described exemplary embodiments. The configuration and details of the present invention are open to various modifications within the scope of the present invention that will be clear to one of ordinary skill in the art.

This application claims the benefits of priority based on Japanese Patent Application No. 2011-211603 for which application was submitted on Sep. 27, 2011 and Japanese Patent Application No. 2012-1325 for which application was submitted on Jan. 6, 2012 and incorporates by citation all of the disclosures of these applications.

### EXPLANATION OF REFERENCE NUMBERS

1 optical element
2 light source device
11 light-emitting element

1. An optical element that is equipped with a plasmon excitation layer that generates surface plasmons wherein:
said plasmon excitation layer is made up of a metal and a dielectric.

2. The optical element as set forth in claim 1, wherein:
said plasmon excitation layer is made up of a composite of a metal and a dielectric.

3. The optical element as set forth in claim 2, wherein:
said plasmon excitation layer includes at least Au or Ag as the metal and a dielectric having a dielectric constant of less than 3 as the dielectric.

4. The optical element as set forth in claim 1, wherein:
said plasmon excitation layer is made up of a multilayer film of a metal and a dielectric.

5. The optical element as set forth in claim 1, wherein:
said plasmon excitation layer is made up of a multilayer film of a dielectric and a composite that is a metal that contains a dielectric.

6. The optical element as set forth in claim 4, wherein:
said multilayer film contains a plurality of types of metal.

7. The optical element as set forth in claim 4, wherein:
said multilayer film includes a plurality of metals and a dielectric.

8. The optical element as set forth in claim 1, wherein:
said plasmon excitation layer is laminated on a carrier generation layer in which carriers are generated by light and has a plasma frequency that is higher than the frequency of light that is emitted when said carrier generation layer is excited by light of said light-emitting element; and
said optical element is equipped with an emission layer that is laminated on said plasmon excitation layer and that converts surface plasmons or light that is emitted from said plasmon excitation layer to light of a predetermined emission angle and emits the light.

9. The optical element as set forth in claim 1, comprising:
said plasmon excitation layer;
a dielectric layer that is laminated on said plasmon excitation layer; and
a fluorescent material layer that is laminated on said dielectric layer and that produces fluorescent light by means of irradiated light;
wherein a diffraction grating is formed on the interface of said dielectric layer and said fluorescent material layer.

10. The optical element as set forth in claim 9, wherein:
the effective dielectric constant of said dielectric layer-side of said plasmon excitation layer is at least 2.25.

11. The optical element as set forth in claim 1, wherein:
said plasmon excitation layer is sandwiched between two layers having dielectricity; and
the effective dielectric constant of an incident-side portion that includes the entire construction that is laminated on said light guide body-side of said plasmon excitation layer is lower than the effective dielectric constant of an emission-side portion that includes the entire construction that is laminated on said emission layer side of said plasmon excitation layer and a medium that is in contact with said emission layer.

12. The optical element as set forth in claim 1, wherein:
said plasmon excitation layer is sandwiched between two layers having dielectricity; and
the effective dielectric constant of an incident-side portion that includes the entire construction that is laminated on said light guide body-side of said plasmon excitation layer is higher than the effective dielectric constant of an emission-side portion that includes the entire construction that is laminated on the emission layer-side of said plasmon excitation layer and a medium that is in contact with said emission layer, and the distance between said plasmon excitation layer and said emission layer is within the effective interactive distance of surface plasmons.

13. The optical element as set forth in claim 10, wherein said effective dielectric constant is determined based on:
the dielectric constant distribution of the dielectric of said incident-side portion or said emission-side portion; and
the distribution of surface plasmons with respect to a direction that is perpendicular to the interface of said plasmon excitation layer in said incident-side portion or said emission-side portion.

14. The optical element as set forth in claim 10, wherein:
where said effective dielectric constant is effective dielectric constant ∈_{eff}, the x-axis and y-axis are directions parallel to the interface of said plasmon excitation layer and the z-axis is a direction perpendicular to the interface of said plasmon excitation layer, ω is the angular frequency of light that is emitted from said carrier generation layer, ∈(ω, x, y, z) is the dielectric constant distribution of the dielectric of said incident-side portion or said emission-side portion, integral range D is the range of the three-dimensional coordinates of said incident-side portion or said emission-side portion, k_{spp,z} is the z-component of the wave number of surface plasmons, and j is imaginary number units, said effective dielectric constant ∈_{eff} satisfies:
$$\begin{matrix}[ Equation 1 ] & \\ {ɛ}_{eff} = \frac{\int {\int }_{D} \int Re [ ɛ ( ω , x , y , z ) ] exp ( 2 j {k}_{spp , z} z )}{\int {\int }_{D} \int exp ( 2 j {k}_{spp , z} z )} \\ or & Equation ( 1 ) \\ [ Equation 2 ] & \\ {ɛ}_{eff} = {( \frac{\int {\int }_{D} \int Re [ \sqrt{ɛ ( ω , x , y , z )} ] exp ( 2 j {k}_{spp , z} z )}{\int {\int }_{D} \int exp ( 2 j {k}_{spp , z} z )} )}^{2} & Equation ( 1.1 )\end{matrix}$$
and moreover, if ∈ₘₑₜₐₗ is the dielectric constant of said plasmon excitation layer and k₀ is the wave number of light in a vacuum, the z-component k_{spp,z} of the wave number of surface plasmons and the x- and y-component kₛₚₚ of surface plasmons respectively satisfy:
$$\begin{matrix}[ Equation 3 ] & \\ {k}_{spp , z} = \sqrt{{ɛ}_{eff} {k}_{0}^{2} - {k}_{spp}^{2}} \\ and & Equation ( 2 ) \\ [ Equation 4 ] & \\ {k}_{spp} = {k}_{0} Re [ \sqrt{\frac{{ɛ}_{eff} {ɛ}_{metal}}{{ɛ}_{eff} + {ɛ}_{metal}}} ] & Equation ( 3 )\end{matrix}$$

15. The optical element as set forth in claim 12, wherein said effective interactive distance of surface plasmons is:
$$\begin{matrix}[ Equation 5 ] & \\ {d}_{eff} = Im [ \frac{1}{{k}_{spp , z}} ] & Equation ( 4 )\end{matrix}$$

16. A projection-type display device comprising:
the optical element as set forth in claim 1;
a display element that modulates emission light from said optical element; and
a projection optical system that projects a projection image by means of emission light of said display element.
